(19) United States
(12) Patent Application Publication
(10) Pub. No.: US 2012/0092663 A1
(43) Pub. Date: Apr. 19, 2012

(54) TRANSMISSION RAMAN SPECTROSCOPY ANALYSIS OF SEED COMPOSITION

(76) Inventors: Linda S. Kull, Charleston, IL (US); Rohit Bhargava, Urbana, IL (US); Bridget Owen, Champaign, IL (US); Matthew Schulmerich, Champaign, IL (US); Dennis Thompson, Mahomet, IL (US); John McKinney, Champaign, IL (US)

(21) Appl. No.: 13/273,684

(22) Filed: Oct. 14, 2011

Related U.S. Application Data
(60) Provisional application No. 61/393,274, filed on Oct. 14, 2010.

(51) Int. Cl. G01J 3/44; G01N 21/01

(52) U.S. Cl. 356/301; 356/244

(57) ABSTRACT

The disclosure provides instrumentation for the Raman spectroscopy analysis of seeds or grains, which can be used to determine the composition of the seed, such as its protein and oil content. In some examples the instrumentation includes an illumination device that emits light in the near infrared range, a sample holder to hold the seeds, and a collection device (e.g., Raman spectrograph) that captures the lights emitted by the seeds. Methods of determining the composition of seeds, such as soybeans, using Raman spectroscopy, are also provided.

### CROSS-REFERENCE TO RELATED APPLICATION

This application claims priority to US Provisional Application No. 61/393,274 filed Oct. 14, 2010, herein incorporated by reference.

### FIELD

This disclosure provides Raman spectroscopy instrumentation, for example that can be used to analyze the composition of soybeans and other seeds or grains, as well as methods for analyzing the composition of soybeans and other seeds or grains.

### BACKGROUND

The current technology standard for grain analysis in the soybean industry is near infrared (NIR) spectroscopy which provides quick and easy whole grain sample analysis. The method relies on near infrared light which is predominately scattered (as opposed to absorbed) by the sample. The scattering of light results in loss of signal or loss of soybean content information, and the more valid light information is in the absorbed portion. The composition of soybeans is obtained by comparing the input of light intensity at each wavelength to the light intensity after it has passed through the soybeans in the sampling chamber. Light across a range of known spectral wavelengths is absorbed by combinations of molecules that correspond to the grain components including protein and oil. The concentrations for protein and oil are obtained by a laboratory reference method, commonly referred to as wet chemistry. A mathematical model is created by comparing the sample spectral data to the data of known reference values for those samples and is used to predict grain composition. The inconsistent scattering of the light, which is influenced by grain structure and moisture, and the accuracy and precision of the reference values heavily influence the ultimate accuracy and precision of the model used and prediction obtained. Accurate and precise prediction of composition is challenging. While the use of NIR light has the advantage of being able to pass through samples, NIR spectral bands arise from absorptions due to combinations of molecular phenomena, or vibrations. Consequently, these spectral bands broadly overlap and generally cannot be assigned to specific chemical functional groups, which are directly associated with the desired grain components.

Additionally, the spectral features that arise from the soybean are always overlapped with spectral features due to water. Water contributes minor spectral variations that are independent of compositional spectral features in the soybean. Soybeans will gain or lose moisture over time based on the humidity of their environment. Therefore, to obtain the least variability in soybean measurements, the soybean grain must be allowed to acclimate to the same ambient conditions as the calibration standards present when the instrument was calibrated. The time and conditions that would be necessary for grain to acclimate is unknown and would likely be impractical for truckloads of soybean grain driving through different weather conditions.

These concerns with NIR spectroscopy arise from the methods low chemical specificity and are further complicated by water in the air entering and leaving the grain. The variability in NIR absorption measurements for soybean has been reported for the soybean industry. As such, much of the error of prediction for NIR may be contributed by moisture. Thus improved methods of determining the composition of soybeans and other crop seeds are needed.

### SUMMARY

Due to the limitations of NIR analysis of crop seeds, a new method using Raman spectroscopy was developed. Analysis of soybeans using microscopic infrared imaging of microtome seed sections demonstrated a significant distribution of protein and oil indicating that point spectroscopy on a whole soybean would not be a representative measure of the bulk sample. Thus, alternative instrumentation to Raman microscopy was needed. Provided herein is Raman spectroscopy instrumentation that permits analysis of whole soybeans and other seeds or whole grains (such as a crop seed), thereby reducing or eliminating the issue of heterogeneity within a seed. The terms seed and grain are used interchangeably herein.

The disclosure provides instrumentation and methods for the determination (e.g., quantification) of seed (e.g., soybean) components, such as oil, sugar, and protein content. For example, provided herein are instruments that can be used to determine the composition of a seed, for example by determining one or more seed components. In some examples, the instrument includes an illumination device (e.g., a laser that emits in the near infrared range), wherein the illumination device is positioned on one side of a sample holder (such as a stage or chamber) capable of holding one or more seeds, and a collection device (such as a Raman spectrograph) positioned on another side of the sample holder (for example a 90 degree configuration or a 180 degree configuration). In a specific example, the instrumentation includes a Raman spectrograph, a fiber optic probe, a sample stage or chamber, collection optics, and a laser that emits in the near infrared range. In some examples, such a device is used when analysis of a single seed is desired (e.g., when one seed at a time is analyzed).

In some examples, the instrument includes an illumination device (e.g., a laser that emits in the near infrared range), wherein the illumination device is positioned on one side of a sample chamber capable of holding a plurality of seeds, and a collection device (such as a Raman spectrograph) positioned on another side of the sample chamber (for example a 90 degree configuration or a 180 degree configuration). In a specific example, the instrumentation includes a Raman spectrograph, a fiber optic probe, a sampled chamber, collection optics, and a laser that emits in the near infrared range. In some examples, such a device is used when analysis of a bulk population of seeds is desired (e.g., when multiple seeds are analyzed simultaneously).

Methods of determining the composition of a seed are also provided, for example by determining one or more seed components. Both single seed and bulk sample compositions can be analyzed using the transmission Raman spectroscopy (TRS) methods provided herein. For example, particular components of a seed can be quantified, such as protein, oil, amino acid, fatty acid, or sugar content, or combinations thereof. In some examples the method includes analyzing the seed using transmission Raman spectroscopy (for example using the instruments described herein), thereby determining the composition of the seed. For example, the seed can be illuminated with a wavelength of near infrared light; and then light emitted from the seed can be detected using a Raman spectrograph, thereby generating a spectra. With TRS, the composition of seeds (e.g., soybeans) can be obtained by observing the Raman response which represents specific vibrational modes arising from molecular vibrations in the seed(s). The absolute or relative intensity of the spectral bands can be used to calculate/predict the concentration of protein and oil (or other desired components) in the seeds, for exmaple by calibrating a set of spectra with the actual or known concentrations for protein and oil (and other components of interest such as amino acids, fatty acids, and sugars). Calibrations can be accomplished by using an appropriate laboratory reference method, such as wet chemistry, as the ‘true value’ for the component of interest. A mathematical calibration model is created by comparing the sample spectral data to the data of known reference values for those samples and is used to predict grain composition.

The foregoing and other objects and features of the disclosure will become more apparent from the following detailed description, which proceeds with reference to the accompanying figures.

### BRIEF DESCRIPTION OF THE DRAWINGS

FIGS. 1A and 1B are graphs showing a representative (A) NIR spectrum and (B) Raman spectrum for a soybean with assigned chemical functional groups. (A) The x-axis represents the spectral wavelength of light detected, and the y-axis illustrates a measure of light absorbance. (B) The x-axis represents the Raman shift from a 785 nm excitation frequency, and the y-axis represents photon counts illustrating the relative contribution of signal from specific functional groups present in the identified constituents.

FIG. 2 shows a series of graphs showing (left) transmission Raman spectrum of corn and soybean (right) NIR absorption spectrum of (top) corn and (bottom) soybean.

FIG. 3A is a schematic representation of an exemplary instrument 100 of the present disclosure. The instrument 100 can include illumination device 110, a sample holder 112 that can hold the seeds to be analyzed, as well as a collection device 114.

The instrument on the left shows a 180 degree configuration, wherein the illumination device 110 and the collection device 114 are opposite to one another, while the instrument on the right shows a 90 degree configuration, wherein the illumination device 110 and the collection device 114 are at 90 degrees to one another relative to the sample holder 112.

FIG. 3B is a schematic representation of an exemplary instrument 200 of the present disclosure. The instrument 200 can include illumination device 210, a sample chamber 212 that can hold the seeds to be analyzed, as well as a collection device 214.

FIG. 3C is a schematic representation of an exemplary instrument 300 of the present disclosure. The instrument 300 can include illumination device 310, a sample chamber 312 that can hold the seeds to be analyzed, as well as a collection device 314. In some examples, the device 300 includes collection optics 320 and collection fibers 322 that collects the Ramn signal and transfers the signal to the collection device 314. In some examples, the device 300 includes a funnel or other chamber 316 to hold the seed, a turning screw or other mechanism 318 to move the seed from the funnel 316 into the sample chamber 312, as well as a trap-door 322 to release the seed from the sample chamber 312.

FIGS. 4A-4C are digital images of an exemplary instrument of the present disclosure (modeled on the exemplary instrument 200 of FIG. 3B).

FIGS. 5A-5C are digital images of screenshots showing the Labview Front panel and block diagrams developed to control the instrument shown in FIGS. 4A-4C.

FIG. 6A is a digital image showing a dark current frame acquired at the same acquisition time as the white light and neon frame, which was unspiked by comparing two sequential frames and removing outlier pixels.

FIG. 6B is a digital image showing the results of loading, unspiking and subtracting the dark frame from the neon frame.

FIG. 6C is a digital image showing the results of loading, unspiking and subtracting the dark frame from the white frame.

FIGS. 6D and 6E are graphs showing the conversion from (D) pixels to (E) wavenumbers using the neon atomic emission frame for calibration.

FIGS. 6F is a digital image showing a dark frame collected at the same acquisition time as the soybeans which was loaded and unspiked.

FIG. 6G is a digital image showing a Teflon frame that was loaded, unspiked, and the sample time dark frame is then subtracted from the Teflon frame. The Teflon frame then undergoes the same pincushion transform.

FIGS. 6H and 6I are graphs showing the wavelength axis for the laser band's spectral position before (H) and after (I) correction.

FIGS. 6J and 6K are graphs showing the signal intensity before (J) and after (K) correcting for instrument throughput and wavelength dependent response of the charged coupled device.

FIGS. 6L and 6M are digital images and graphs showing the soybean spectra before (L) and after (M) the preprocessing correction illustrated in FIGS. 6A-6K.

FIG. 6N is a graph showing the average spectra of FIG. 6M.

FIGS. 7A and B show graphs comparing the predicted oil (A) and protein (B) content using Raman spectroscopy (y-axis) wet chemistry (x-axis) analysis.

FIGS. 8A and 8B are (A) a CAD image and (B) digital image of an exemplary instrument of the present disclosure for Raman seed analysis (modeled on the exemplary instrument 300 of FIG. 3C).

FIG. 8C are images showing (Top left) prototype of the spinning lens-let array. (Bottom left) Digital image of the 12 collection points acquired by the lens-let array. The collection points rotate during the measurements acquisition time effectively collecting from two concentric ring-like field of views. (Top right) Illustration of the instrument's optical path. (Bottom right). TRS collected with this instrument with soybeans in the sample chamber.

FIG. 9 is a graph showing Raman data collected from 26 different soybean varieties with varying concentrations of amino acids, fatty acids and sugars. This data was collected with the bulk transmission Raman instrument depicted in FIG. 8B.

FIGS. 10A-C are graphs showing calibration curves using the bulk transmission Raman instrument depicted in FIG. 8B, for (A) aspartic acid, (B) lysine and (C) sucrose. The graphs on the left show the RMSE (route mean squared error) using various partial least squares loadings. The graphs on the right show calibration models (circles) and predicted validation points using the calibration models (triangles) for (A) aspartic acid, (B) lysine and (C) sucrose.

FIG. 11 is a graph showing the validation set independent of the calibration set illustrating the Raman protein prediction versus wet chemistry results for 40 individual whole soybeans, the shaded area represents the error (3 standard deviations from the mean) in the wet chemistry measurements.

### DETAILED DESCRIPTION

The singular forms “a,” “an,” and “the” refer to one or more than one, unless the context clearly dictates otherwise. For example, the term “comprising a seed” includes single or plural seeds and is considered equivalent to the phrase “comprising at least one seed.” The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. All references cited herein are incorporated by reference. The schematic drawings are provided for illustration purposes, and are not necessarily to scale.

### Overview

Raman spectroscopic imaging permits one to obtain chemically specific information without the need for dyes or labels. A Raman spectrum can be obtained optically and can be acquired non-invasively and non-destructively. Thus it can be used to examine the chemistry of a biological sample because only light interacts with the sample and as a result, the sample remains unchanged after measurements. The disclosed methods and instrumentation provide automated, non-destructive detection and quantification of seed components and attributes using transmission Raman spectroscopy (TRS). The disclosed methods and instrumentation permit individual or bulk whole seed analysis, which provides quantifiable metrics for differences in seed attributes that are important for decision making in health, material, and biological sciences, such as for food, feed, fiber, and biofuels. For example, the disclosed methods and instrumentation permit the identification of particular seeds or batches of seeds that have one or more desired characteristics or components. Seeds that lie toward the edges of the normal distribution, such as those that are particularly high or low in a particular attribute, can be of great interest, and can be identified using the methods and instrumentation provided herein. For example, the methods and instrumentation provided herein permit the rapid and nondestructive evaluation of corn lysine levels or rice pasting characteristics, which can speed development of new cultivars or lead to improved varieties. In addition, the disclosed methods and instrumentation permit the generation of spectral collections/libraries of different seed components.

Methods and instrumentation for non-destructive seed analysis that can accurately and precisely provide the composition of seeds is not currently available. Some currently available methods involve sub-sampling the seed and then destroying it in order to extract and analyze components of interest. For example, one method of analyzing total protein involves grinding the seed into a powder, then burning the powder and analyzing the nitrogen that is released during combustion. To determine the amino acid concentrations, the seed is again ground into a powder and proteins are dissolved into a solvent. The solution of protein and solvent is then run through a High Pressure Liquid Chromatography (HPLC) instrument in order to separate the amino acids of interest from each other, and the total concentration of each amino acid of interest is discerned by quantifying bands on the chromatograph. Although Near Infrared Spectroscopy (NIRS) is non-invasive and can quantify components such as total protein, oil, or water, it is physically limited by the inherent chemical specificity of the technique. The absorption spectral bands resulting from NIRS broadly overlap and generally cannot be assigned to specific chemical functional groups, which are directly associated with the desired seed component, hence limiting the chemical specificity that is available with NIRS.

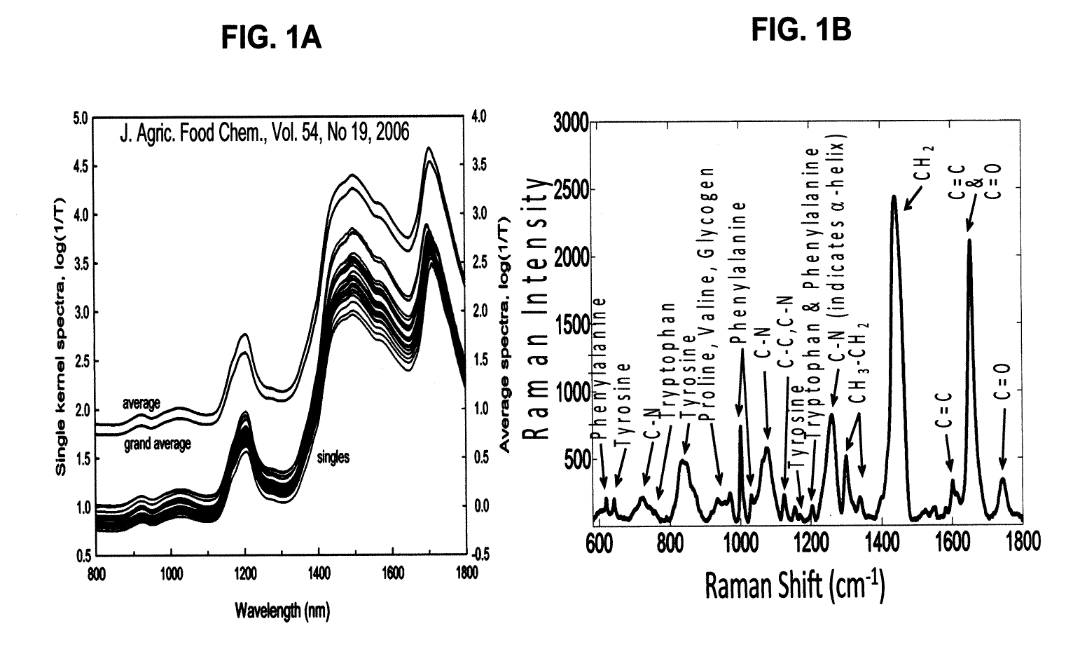

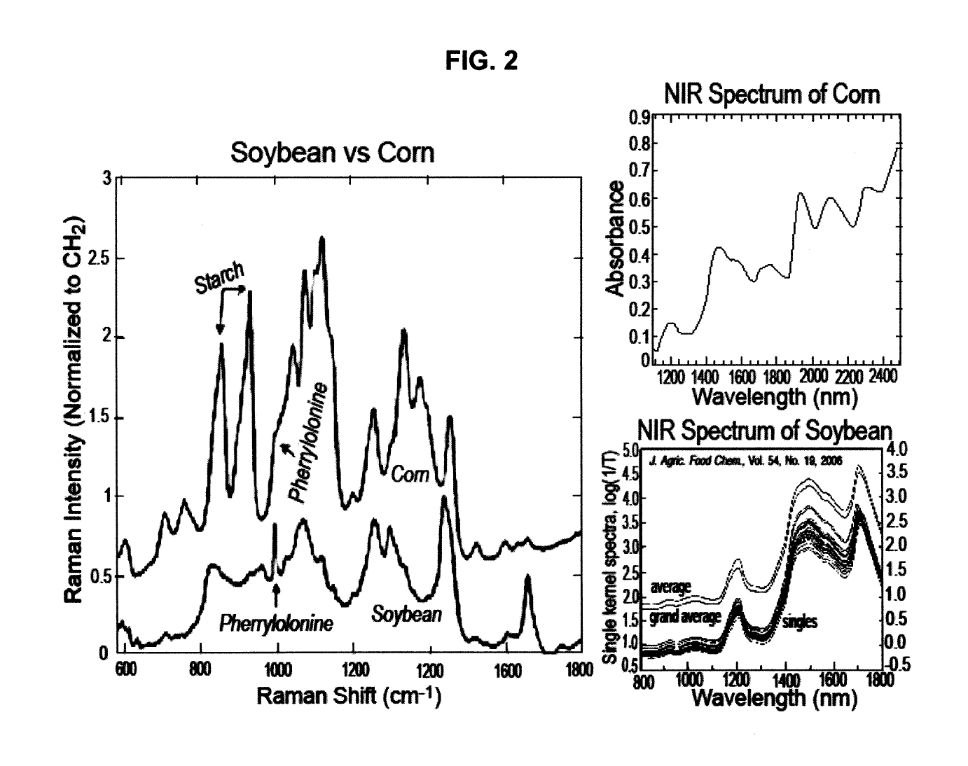

Provided herein are methods and instrumentation using Raman spectroscopy to determine the composition of seeds. Raman spectroscopy technology is highly chemically specific and is an improvement over current technologies used for seed analysis. Chemical specificity is the ability to discern one chemical species from another by means of spectral peaks/bands. A spectrum consists of a signal response termed bands/peaks as a function of wavelength. The number and combination of unique spectral bands along with the bandwidth of each band are general markers that can be used to compare chemical specificity between spectral methods. Thus, one advantage of Raman spectroscopy is that the spectral resolution (chemical specificity) is far superior to that of a NIR spectrum. The spectral bands are much narrower and can be assigned to specific chemical groups whereas with NIRS the spectral bands cannot be assigned to specific chemistry. For example, FIGS. 1A and 1B compare a NIR spectrum of a soybean (FIG. 1A) and a Raman spectrum of a soybean (FIG. 1B). The Raman spectrum shows narrower spectral bands that can be directly assigned to specific chemistry (functional groups) including bands correlated with specific amino acids. This chemical contrast translates into more information. For example, FIG. 2 shows Raman spectra acquired from corn as compared to the Raman spectra acquired from soybean. The spectral band highlighted at 1003 cm-1 Raman shift arises from a ring breathing vibrational mode attributed to phenylalanine. The spectral band is present in both the Raman spectra for soybean and corn; however the relative intensity is much higher for the soybean indicating that a soybean has a higher weight percentage of phenylalanine. This is in fact the case. According to the USDA nutrition database, 100 g of soybean will contain 2.12 g of phenylalanine (2.12% by weight) while 100 g of corn will contain 0.150 g of phenylalanine (0.15% by weight). Similarly, the starch (carbohydrates) is readily apparent in the Raman spectrum of corn, while as expected it is absent from the Raman spectrum of a soybean. The same chemical assignments cannot be made for the NIR spectrum of corn and soybean illustrated on the right side of FIG. 2, thus illustrating a greater utility for Raman spectroscopy in identifying a sample's chemistry.

Raman based instrumentation has the capacity to nondestructively, accurately and precisely, analyze seeds (such as corn, rice, soybean, and wheat grains) for nutritional components and other chemicals at any point of interest from seed development to field production through to end-use. TRS illuminates and collects in a similar fashion to that of NIRS where one side of the sample is illuminated and the photons diffuse through to be collected on the opposite side.

For example, the oil content, protein content (such as crude protein), amino acid content (e.g., Asp, Tyr, Phe, Lys, Met, Cys, Trp, Thr), fatty acid content, sugar content, gluten content, ash content, lipid content carbohydrate content, starch content or density (e.g., chalkiness), or combinations thereof (such as oil and protein content), can be determined, and in some examples quantified. In other or additional examples, the oligosaccharide, alpha-amylase, isoflavone, can be determined, and in some examples quantified. For example, the disclosed methods can be used to identify and determine additional components of seeds, such as isoflavones, known to enhance animal (e.g., pigs, poultry, fish, or cows) and human health.

Non-nutritional agents can also be detected, such as metabolic residues associated with a specific organism (such as an aphid, nematode, fungus, bacteria or virus (or other type of known plant insect or pest) including but not limited to those microbes that cause Anthracnose, Bacillus Seed Decay, Bacterial Blight, Bacterial Pustule, Bean Pod Mottle Virus, Brown Stem Rot, Charcoal Rot, Frog Eye Leaf Spot, Green Stem Disorder, Phomopsis Seed Decay, Phytophthora Rot, Pod and Stem Blight, Red Leaf Blotch, Rhizoctonia Root Rot, Sclerotinia Stem Rot, Septoria Brown Spot, Soybean Aphid, Soybean Cyst Nematode, Soybean Mosaic Virus, Soybean Rust, Stem Canker, Sudden Death Syndrome (caused by Fusarium virguliforme), Tobacco Ringspot Virus), mycotoxins (aflatoxins, as well as the toxin(s) produced by Fusarium toxins, etc.), and in some examples they may be quantified.

The disclosed methods and instrumentation can be used to discern individual amino acids, such as phenylalanine (e.g., see FIG. 2). Rapid measurement of specific amino acids in soybean or corn and their by-products (e.g., soybean meal and distillers dried grains with solubles (DDGS)) is important for feeders of livestock and poultry. Of the twenty common amino acids, the key amino acids for animal nutrition are lysine, tryptophan, cysteine, methionine and threonine. Because precise levels of amino acids in corn and DDGS are seldom known, livestock and poultry producers have to formulate feed assuming the lowest possible average levels of nutrients. If more accurate levels of key amino acids in feed ingredients were known, excess amino acids that are non-digestible by the animals could be saved. For breeders of soybean and/or corn, rapid, low-cost measurements of key amino acids also are important in selection of lines for advancement.

Jenkins et al. (“Characterization of amino acids using Raman spectroscopy,” Spectrochimica Acta—Part A: Molecular and Biomolecular Spectroscopy, vol. 61, pp. 1585-1594, 2005) has shown that Raman spectroscopy can measure the twenty common amino acids in hydrocarbon, alcohol, sulfur, amide, basic, aromatic, secondary amine, and acidic classes, individually as pure substances. For example, Jenkins et al. (Id.) provides the Raman spectra of five amino acids (L-phenylalanine, L-tyrosine, L-typtophan, L-histidine, and L-proline) illustrating the narrow band high chemical specificity of the technique. Additional information on the Raman spectra for other amino acids and other chemical species can be found in Gelder et al., J. Raman Spectroc. 38:1133-1147, (2007).

Fatty acids can also be detected. Fatty acids that can be detected include linolenic acid, linoleic, oleic acid, stearic acid, and palmitic acids. For soybeans, low linolenic (3 percent or less) is desirable because linolenic acid causes oxidative instability (which leads to rancidity of oil). If linolenic is low, it eliminates or reduces the need for chemical oxidation, which eliminates the trans-fats that would have been produced. Trans-fats are detrimental to cardiovascular health. High oleic acid is desired because it is monounsaturated oil, and it is less susceptible to oxidative instability. 60%-75% oleic acid would be considered mid to high. Low saturated fatty acids also are desired, and if low enough, oils can meet the FDA standard for labeling as a low-saturated oil. Rapid low-cost measurements for fatty acids are needed for breeders in selecting lines with desired characteristics and for food processors to meet labeling requirements. Raman spectroscopy can be used to detect lipids as shown in Thygesen et al. (Trends in Food Science and Technology, 14:50-57, 2003).

The content of any seed can be determined, such as a crop seed, for example a cereal or oil seed. In particular examples the seed is a soybean, corn, wheat, rice, oilseed, cotton, and the like. In some examples the seeds are analyzed individually (that is, the composition of one seed is determined in isolation), while in other examples seeds are analyzed in bulk (that is, the composition of a plurality of seeds is determined as a whole at the same time, for example by placing a plurality of seeds in a container and performing Raman spectroscopy on the entire container).

Also provided is Raman instrumentation that can be used in the disclosed methods, for example to determine seed composition. The Raman instrumentation enhances the degree of accuracy and precision currently achieved by traditional NIR predictive measurement approach to determine protein and oil content of seeds (e.g., soybean). The Raman instrumentation allows for single seed or bulk seed analysis. In some examples, the single seed determinations are used by breeders and the scientific community for evaluation by non-destructive means. In some examples, the bulk determinations are used by the commercial industry.

Raman spectroscopy provides robust compositional analysis of the multiple attributes contained in whole seed samples with greater accuracy and/or precision than can be achieved with conventional NIR spectroscopy. Raman spectroscopy differs from NIR spectroscopy because it uses only one wavelength of light which can be chosen from the NIR spectrum and thus can maintain the necessary penetration of light that is achieved with NIR spectroscopy. With Raman spectroscopy, when the light travels through the whole seed, it interacts with molecules in the sample and transfers some of its energy to molecular vibrations in predictable ways depending on the molecules present in the sample. Therefore, some of the light emitted from the seed is at different energy levels than the light that was put into the whole seed sample. This difference in energy arises as a result of specific chemical groups in the whole seed. Similar to NIR spectroscopy, the composition, or chemical groups, of the seed can be calculated by comparing a test seed of unknown composition to a calibration curve generated from seeds with known chemistry. Exemplary advantages of Raman spectroscopy are that the spectral resolution (chemical specificity) is far superior to that of NIR spectra, and water does not significantly influence the analysis model. The spectral bands are much narrower and can be assigned to specific chemical groups in the seed. A higher specificity for chemical groups in the sample translates into more accurate, precise and robust mathematical models as compared to NIR. Additionally, seed moisture has less of an impact, possibly negligible, on the model which results in more accurate and precise measurements on seed composition.

The disclosed methods and instrumentation can be used to assist with phenotyping of individual plants; confirm protein structures and configurations in grains; use the results to develop genotypes with improved amino acid and fatty acid characteristics; determine amylose content and starch pasting characteristics to create rice with improved cooking quality; determine nutrient deposition in seeds, timing and influence of environment on the seed-fill stage; construct rapid seed separation instruments designed to detect a specific chemical component; conduct total grain quality analysis for traceability studies throughout the supply chain; detect specific chemicals at lower thresholds than currently achievable; evaluate seeds for sprout damage and protein quality; conduct real-time studies of nutrient, pathogen, and toxin movement in seeds; seed analysis for presence or absence of protein signatures; track nanomaterials introduced into grains (e.g., carbon nanotubes); create spectral databases/libraries for seeds or combinations thereof.

Quantifying the composition of various nutritional components is a need in the animal feed industry. The nutrient compositions of all feeds vary, but using feeds that are highly variable can reduce production in livestock operations. Reduced production occurs when a diet does not contain adequate concentrations of a particular nutrient because a feed has less than anticipated concentrations of that nutrient. Increased feed costs occur when diets are over supplemented to avoid reduced production. Seed nutrient composition is an important component of nutrient management planning and animal ration formulation.

Development and identification of seeds with superior attributes can lead to improvements in plant and animal health, food safety and nutrition, and biofuels. The seed research community can benefit from instrumentation and spectral databases that can routinize seed analytics and provide significantly improved accuracy and precision of seed composition and attributes.

### Instrumentation

The present disclosure provides instrumentation that can be used to perform the disclosed methods, for example determining the composition of crop seeds and grains. However, one skilled in the art will appreciate that the disclosed instrumentation can be used for other purposes.

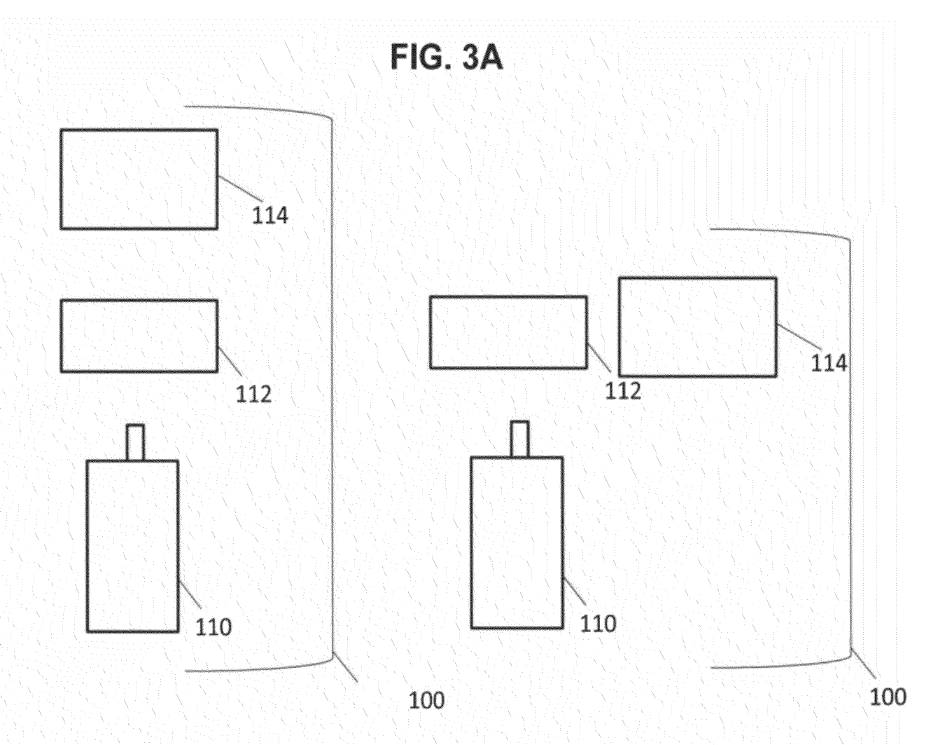

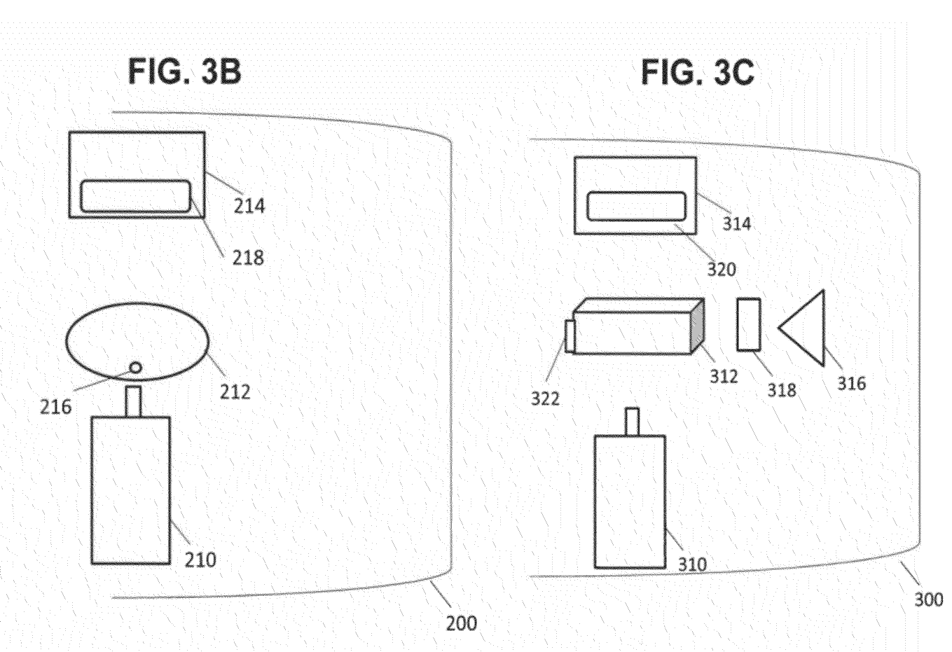

The instrument includes an illumination device, a collection device, and optionally sample plate or stage or chamber for holding the seed to be analyzed. For example, as shown in FIG. 3A, the instrument 100 can include illumination device 110, such as a laser that emits light in the near infrared range, a sample holder 112 (such as a stage, plate or chamber) that can hold one or more seeds to be analyzed, as well as a collection device 114 that is capable of collecting the light emitted from the sample after it has been illuminated by the illumination device 110.

The illumination device 110 can include a laser that emits light in the near infrared range (such as 633 nm to 1064 nm, for example, 780 to 790 nm, or 785 nm). In some examples, the illumination device 110 further includes fiber optic(s) to transmit the light from the laser to collimating and focusing optics. Generally, the illumination device 110 is placed on one side of the seed to be analyzed, while the collection device 114 is on another side of the seed to be analyzed. The configuration shown in FIG. 3A on the left shows a 180 degree configuration such that the illumination device 110 is placed on one side of the seed to be analyzed, while the collection device 114 is on the opposite side of the seed to be analyzed (e.g., 180 degrees). However, one skilled in the art will appreciate that other configurations can be used, such as the 90 degree geometry shown in FIG. 3A on the right (wherein the illumination device 110 is placed on one side of the seed to be analyzed, while the collection device 114 is positioned about 90 degrees away).

The sample holder 112 holds the seeds to be analyzed. In some examples (e.g., when seeds are analyzed individually, see FIG. 3B) the sample holder 212 (which can for example be spherical), contains indentations/wells 216 capable of holding one or more seeds. In some examples (e.g., when seeds are analyzed in bulk, see FIG. 3C) the sample holder 312 is designed to hold seeds in bulk (for example, a chamber for holding a plurality of seeds, such as at least 20, at least 50, or at least 100 seeds, such as 20 to 100 or 50 to 500 seeds). In some examples the stage is made of a metal, such as aluminum, brass, or stainless steel.

The collection device 114 is capable of collecting the light emitted from the sample after it has been illuminated by the illumination device 110. For example, the collection device 114 can include focusing optics and a fiber bundle that transmits the emitted light to a spectrograph. As shown in FIG. 3A, the collection device 114 can be located opposite to the illumination device 110 or 90 degrees to it. In some examples, the seed is surrounded with collection fibers for collection of emitted signal.

In one example such a device is used for analyzing single seeds (e.g., analyzes one seed at a time). For example, as shown in FIG. 3B, the instrument 200 can include illumination device 210, such as a laser that emits light in the near infrared range, a sample holder 212 that can hold the seeds to be analyzed, as well as a collection device 214 that is capable of collecting the light emitted from the sample after it has been illuminated by the illumination device 210. Although a 180 degree configuration is shown, one will appreciate that other configurations can be used, such as a 90 degree configuration. In this example, the sample stage 212 can contain indentations/wells 216 capable of holding one or more seeds. In some examples, the stage includes a plurality of concentric indentations. Within the indentations is a centered hole (such as a hole 0.5 to 10 mm in diameter, such as 1 mm, 2 mm, 3 mm, 4 mm, or 5 mm diameter) that permits light from the illumination device 210 to come in contact with the seed present on the indentation. In some examples the sample stage 212 is spherical, but the discloser is not limited to particular shapes. Light is transmitted through the seed by the illumination device 214, and the composition, or chemical groups, of the seed determined by comparing the test seed of unknown composition to a calibration curve based on reference chemistry of known seeds. In some examples, the collection device 214 includes collection optics 218 (such as a single lens or a lenslet array) that collects the transmitted Raman signal from the seeds and relays it to a bundle of collection fibers. The collection fibers, which can be part of the collection device 214, transmit the collected light to the collection device 214 (such as an imaging Raman spectrograph and charged coupled device (CCD)).

In another example such a device is used for analyzing a plurality of seeds (e.g., analyzes a population of seeds simultaneously). For example, as shown in FIG. 3C, the instrument 300 can include illumination device 310, such as a laser that emits light in the near infrared range, a sample chamber 312 that can hold the seeds to be analyzed, as well as a collection device 314 that is capable of collecting the light emitted from the sample after it has been illuminated by the illumination device 310. In this example, the sample chamber 312 can be appropriately sized (or be sizeable) to accommodate the number of seeds to be analyzed. Collection can be achieved with collection optics 320 (such as a single lens or a lenslet array) that collects the transmitted Raman signal and relays it to a bundle of collection fibers. The collection fibers transmit the collected light to a collection device 314 (such as an imaging Raman spectrograph and charged coupled device (CCD)).

In some examples, the device 300 includes a funnel or other storage container chamber 316 to hold the seed, which allows the seed to be transported to the sample chamber 312. A turning screw or other mechanism 318 can be included to move the seed from the funnel 316 into the sample chamber 312, as can a trap-door 322 (which can be part of the sample chamber 312) to release the seed from the sample chamber 312, emptying the sample chamber 312 for additional runs. Once the measurement is acquired, the seeds will empty from the chamber 312 and will refill with seeds located in the storage container 316. Light is transmitted through the seed by the illumination device 314, and the composition, or chemical groups, of the seed determined by comparing the test seed of unknown composition to a calibration curve based on reference chemistry of known seeds. The measurement can be acquired in transmission mode through a variable path-length window with a diameter of two inches. In one example the illumination device 314 is a 785 nm laser, such as one that excites the sample with ˜250 mW of power, which is collimated onto the sample with a one inch (or two inch) diameter beam waste. However, one skilled in the art will appreciate that more powerful lasers can be used, such as a 785 nm laser that is at least 1 Watt, at least 2 Watts, at least 5 Watts, such as 5 to 6 Watts. The use of a more powerful laser will result in faster acquisition times, higher signal to noise, and larger sampling volume.

Thus the disclosure provides an instrument for determining the composition of a seed, such as the protein, amino acid, and oil content of the seed. In some examples the instrument includes an illumination device, a sample holder capable of holding one or more seeds, wherein the illumination device is positioned on one side of the sample holder, and a collection device, wherein the collection device is positioned on the anther side of the sample holder. For example, the illumination device can include a laser capable of emitting light in the near infrared range, such as light at 785±5 nm. In some examples the illumination device further includes a fiber optic patch-chord/bundle, collimating optics, and focusing optics, wherein the fiber optic bundle transmits light to collimating and focusing optics. The sample holder can optionally include a plurality of concentric indentations that can hold individual seeds. In some examples, the collection device includes a Raman spectrograph (such as one with a 400-1800 cm⁻¹ Raman shift grating). The collection device can also include a fiber optic bundle connected to the spectrograph, such that light from the fiber optic bundle can be transmitted to the spectrograph. For example, the fiber optic can include fibers arranged in a linear array and fibers arranged in a rectangular array. Focusing optics can also be part of the collection device, such as a 30 mm focal length lens positioned to focus light emitted form the seed following illumination of the seed. In some examples the spectrograph includes a charged-coupled device (ccd). In some examples the collection device includes a cylinder lens, Powel lens, or a lenslet array.

### Illumination

The illumination configuration includes a laser that emits light in the near IR (NIR) range, such as lasers that emit light in the 633 nm to 1064 nm range, such as 700 nm to 800 nm, 750 nm to 790 nm, 780 nm to 790 nm, or about 785 nm. In one example, the instrument will illuminate by sweeping a range of wavelengths (e.g., 700 nm to 1200 nm). In one example, the laser emits a single wavelength of light, such as 785±5 nm light. With NIR light, scattering dominates over absorption resulting in light being able to transmit through large path lengths (on the order of 18-50 mm).

When the light travels through the whole seed (or population of seeds), it is temporarily absorbed and then emitted or released by the molecules in the sample. This temporary absorption and release of the photon is a form of scattering. If the photon was released at the same energy (wavelength) that it went in as, then the photon is said to be Rayleigh (elastically) scattered. If the photon was released at a lower energy (higher wavelength) then the photon is said to be Raman (in-elastically) scattered. In the case of Raman scattered light, some of the energy from the photon is transmitted to the vibrational energy of the molecule. This transfer of energy occurs in predicable ways based on the groups of molecules that are present. By illuminating with a laser, billions of photons all with the same energy (wavelength) are put through the sample. A Raman spectrometer will reject the photons that are the same energy (wavelength) and transmit the lower energy (higher wavelength) photons through to a grating that will then separate the Raman photons by wavelength and transmit them to an array detector where each pixel is a different wavelength. The Raman spectrum is therefore a histogram of photon counts representing Raman photons shifted from some excitation frequency. The x-axis of a Raman spectrum is titled Raman shift and is labeled in wave numbers. For a given vibrational mode, this Raman shift (x-axis position) will be the same regardless of excitation frequency. Therefore any wavelength can be selected to generate a Raman signal. In the case of seed analysis, a NIR wavelength (e.g., 785 nm) is chosen because NIR light will scatter through the sample as opposed to being absorbed by the sample, thus retaining the necessary penetration depth and sampling volume for seed analysis.

The laser light can be transmitted from the laser to collimating and focusing optics using a fiber optic cable. The light can then be focused on a spot of about 1 μm to 5 mm in diameter (such as about 1 mm, 2 mm, 3 mm, 4 mm, or 5 mm diameter) on the seed to be analyzed. The power of the laser needed can depend on the thickness of the seed to be analyzed. In some examples, the laser is at least 100 mW, at least 200 mW, least 300 mW, at least 500 mW, at least 1000 mW, at least 2 Watts, at least 5 Watts, such as 5 to 6 Watt or such as 200 to 500 mW.

In a particular example, the laser is a 400 mW, 785 nm laser (Kaiser Optical Systems, Inc., part of the RXN1 system). This is a very stable, continuous wave, narrow spectral band diode laser with built in temperature controls, filters, fiber-launching optics, and power attenuation. The light is carried from laser to the sample using a 300 μm core fiber optic patch chord. The light from the fiber can be collimated using a collimating package (such as available from Thorlabs, Newton, N.J.) and focused onto the bottom surface of a seed to about a 2 mm diameter spot. In another particular example, for example for bulk seed analysis, the 785 nm laser with the same 300 μm fiber is used, and the light collimated using a 2 inch 100 mm focal length achromatic lens (such as available from Thorlabs, Newton, N.J.). The NA of the fiber is about 0.22, so that the light diverges at an angle such that when the light is collimated 100 mm away from the tip of the fiber, the waste of the beam will be about 2 inches. One skilled in the art will appreciate that other configurations can be used, such as a 50 mm focal length lens positioned 50 mm away from the tip of the fiber to obtain a beam waste of about 1 inch. One skilled in the art will appreciate that other lasers can be used, though in specific examples a narrow band stable laser for Raman spectroscopy is used.

### Sample Holder

The instrument can include an area for holding the seeds to be analyzed. In one example, the sample holder is a stage or platform that can include one or more indentations/wells where individual seeds to be analyzed are placed. Such indentations may include a hole that permits light from the illumination device to pass through to the seed. For example, each well has a centered-through hole that is at least 0.5 mm in diameter (for example about 1 mm to 5 mm in diameter, such as about 1 mm, 2 mm, 3 mm, 4 mm, or 5 mm diameter) which allows for the passage of laser light to the seed to be analyzed. In a specific example the stage includes two concentric rows of wells positioned at known locations along the outer edge a circular aluminum plate.

In other examples, the stage holds a container of a plurality of seeds to be analyzed (e.g., for bulk seed analysis). For example, the stage may hold a clear container containing two or more seeds to be analyzed. In some examples where a plurality of seeds is analyzed, the stage is optional, an instead the container holding the seeds is placed between the illumination and collection devices.

In some examples the stage for holding the seeds to be analyzed can be automated. For example, the sample plate can be attached to a rotation stepper motor and a translation motor which are both controlled with software to move the samples into position for data acquisition. In a specific example, this allows for the analysis of up to 160 seeds automatically. One skilled in the art will appreciate that there are other ways to set-up sampling automation including and xyz stage as opposed to a rotation stage.

In some examples, the seed holder is a chamber that holds the population of seeds to be analyzed. For example, the chamber can be configurable, to hold different seeds or different numbers of seeds. Such a chamber may be made of a material that permits light from the illumination device to pass through to the seeds in the chamber. In some example, the sample chamber includes a material that allows near infrared light to pass through, such as glass, silica, or plastic. In one example, the sample chamber has a window (such as a window that is at least 0.5 inches in diameter, such as at least 1 inch, at least 2 inches, or at least 3 inches, such as 2 inches in diameter) that allows collimated laser light to pass through. The light is incident onto the seeds, and then the light scatters through the sample and is emitted through a second window (such as a window that is at least 0.5 inches in diameter, such as at least 1 inch, at least 2 inches, or at least 3 inches, such as 2 inches in diameter). The two windows can be at 180 degrees to one another, or at 90 degrees to one another, for example. The collection optics are focused through the second window to collect the light. Thus, the seeds to be analyzed can sandwiched between the two windows. In one example the distance between the 2 windows at least 0.1 inches, at least 0.5 inches, or at least 1 inch (such as 0.5 inches). However, one skilled in the art will appreciate that this distance can be varied sliding the two windows. In some examples the sample chamber for holding the seeds to be analyzed can be automated. For example, the sample chamber can be attached to (or include) a trap door and a filling port, which are both controlled with software to move the seeds from a storage area (such as a funnel) into the sample chamber for data acquisition, and then release of the seeds from the chamber once the data is obtained. One skilled in the art will appreciate that there are other ways to set-up sampling automation.

### Collection Device

The collection device allows for collection or acquisition of light that is emitted from the seed(s) after it is illuminated. The collection device can include optics that focus the light emitted from the seed(s) (e.g., collection optics) and a fiber bundle (e.g., collection fibers) that collects the light emitted from the seed(s). The fiber bundle can transmit the collected light to a spectrograph. The components of the collection device can be mounted onto an apparatus.

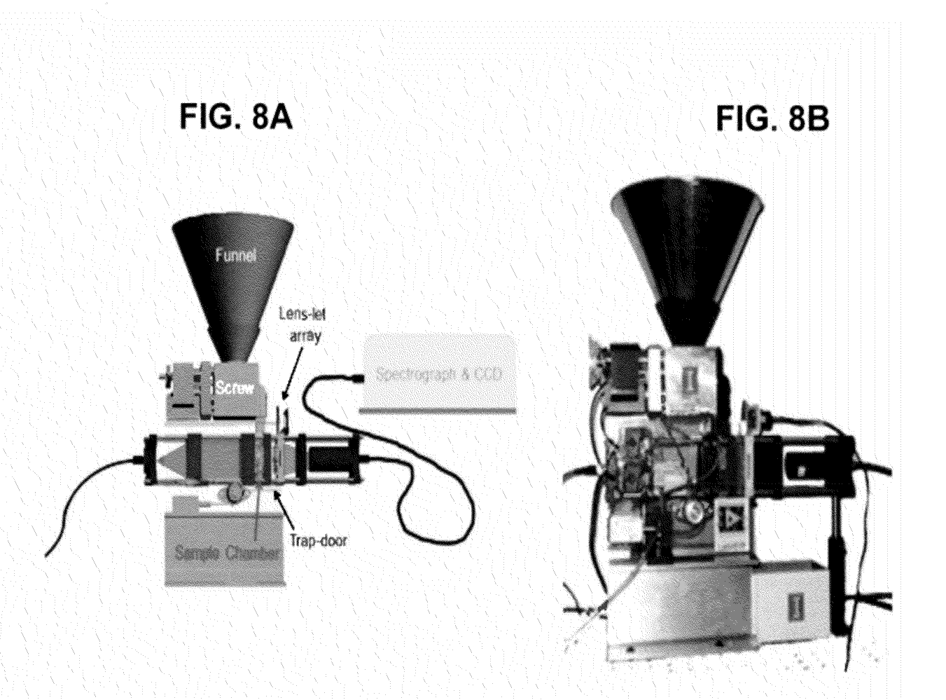

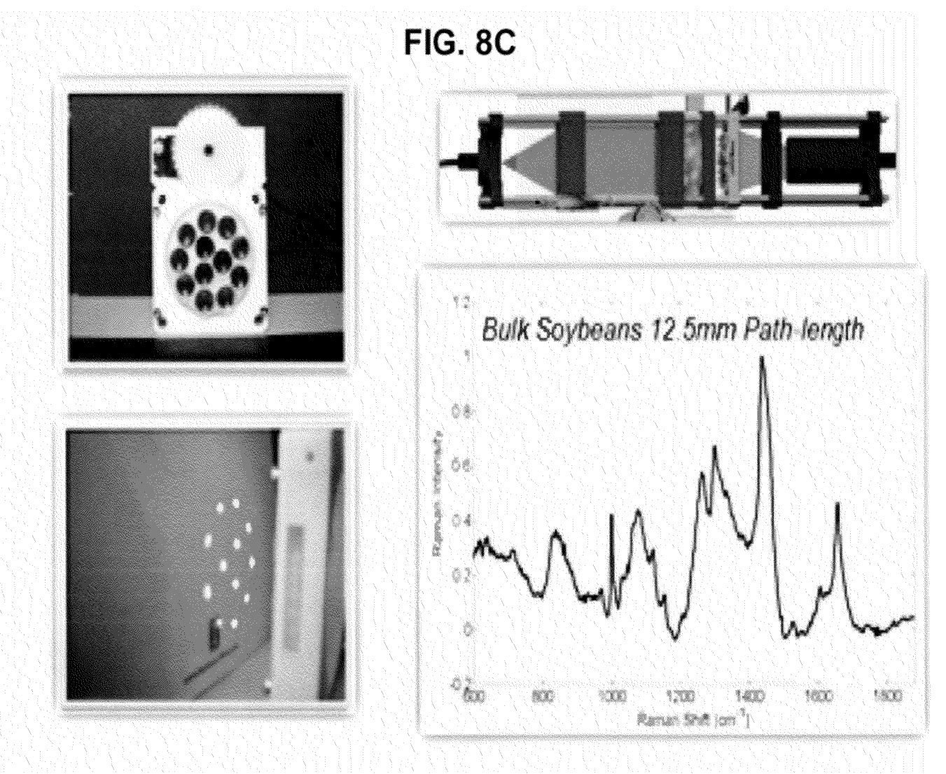

In one example, the focusing optics include a 30 mm focal length lens positioned onto an automated stage that focuses onto the seed and collects light from the seed(s). The light is transmitted to a 60 mm focal length lens which delivers the light to the collection fibers. In some examples, a high numerical aperture (NA) from the 30 mm focal length lens and a high effective F/# from the fiber array which acts like a lenslet array is achieved. There are other ways to achieve both high F/# and high NA using free space optics including the use of a cylinder lens, Powel lens (as stated above) or a lenslet array. In another example, the focusing optics include a plurality of lenses, such as a lenslet array. In one example, 12 lenses are used in a rotating lenslet array to collect and collimate the light (see e.g., FIG. 8C). For example, light can be relayed from the sample to a bundle of collection fibers by the lenslet array followed by 4 to 1 beam reducing telescope, and then focused onto the collection fibers using a 50 mm focal length lens.

The collection device can include a spectrograph (such as a Raman spectrograph) to which the emitted light is transferred. The spectrograph can be designed to include only the low frequency Raman shift (e.g., about 400-1800 cm⁻¹ Raman shift) and to include adjustment tools for aligning the system for custom fiber optic inputs. The spectrograph can include a pre-stage notch filter and a 50 μm slit, an axial transmissive grating (400-1800 cm⁻¹ Raman shift), and a CCD array (256×1024 pixels). In one example the spectrograph is supplied by Kaiser Optical Inc. (Ann Arbor, Mich.) and is part of the 785 nm RXN1 Raman system. This system can be simplified by using a linear array CCD combined with a Czerny-Turner style spectrograph. In one example the CCD is NIR optimized, for example to improve the quantum efficiency in photon counting (e.g., iDus 420 BR-DD available from Andor Technology). In some example, a cooling system is included.

Light can be directed to the spectrograph using a fiber optic bundle, such as those supplied by FiberTech Optica (Ontario, Canada). In one example, the bundle includes 50 100 μm core fibers with stripped cladding one each end to facilitate close packing. At the spectrograph the fibers are arranged into a linear array (e.g., 1×50 or 7×7) and are imaged onto the ccd through the spectrograph. At the sample the fibers can be arranged into a rectangular or other array (e.g., 5×10 or 7×7). In some examples, instead of using fiber optics as the collection scheme, a Cylinder lens or a Powell lens in conjunction with free space optics can be used.

### Methods of Analyzing a Seed Using Raman Spectroscopy

The disclosure provides methods for determining the composition of a seed or bulk seed population by analyzing the seed(s) using transmission Raman spectroscopy. In some examples the instruments described herein are used to analyze the samples. Any seed or whole grain can be analyzed using the disclosed methods, such as crop seeds. Exemplary crop kinds include, but are not limited to cereals (e.g., corn, wheat, sorghum, rice), oilseeds (e.g., soybean, sunflower, canola, rapeseed, palm, flax), pulses (e.g., kidney bean, lentil), vegetables (e.g., tomatoes, lettuce), fruits (e.g., oranges, papayas), and tubers (e.g., potatoes). In one example, the seed is a grass seed, such as one used in animal feed or one used for lawns and the like.

In one example, the seed or grain is intact (this is it is a whole seed or grain that has not been cut or otherwise degraded or destroyed). Exemplary characteristics of seeds that can be analyzed including protein content, oil content, amino acid content (such as Asp, Tyr, Phe, Trp, His, Cys, Pro, Lys, Met, Trp, Thr), fatty acid content, or sugar content (for example a simple sugar such as sucrose or a complex sugar such as starch).

In some examples, a single seed is analyzed at a time. That is, spectra are obtained for individual seeds. In some examples, the spectra are obtained for a plurality of individual seeds, and the resulting spectra can be averaged. In other examples, a plurality of seeds is analyzed simultaneously. For example, two or more seeds, such as at least 10, at least 100, or at least 500 seeds are placed into a clear container, and the container illuminated and spectra generated representing the plurality of seeds in the container.

The method can include illuminating the seed with a near infrared wavelength of light, and then detecting light emitted from the seed using a Raman spectrograph. For example, a laser can be used to illuminate the seed at a wavelength of 633 nm to 1064 nm, such as 700 nm to 900 nm, 700 nm to 800 nm, 750 nm to 790 nm, 780 nm to 790 nm, for example 785±5 nm. In particular examples the seed is illuminated for at least 1 minute, such as at least 5 minutes or at least 10 minutes, such as a total of 1, 2, 3, 4, 5, 6, 7, 8, 9, 10, 15, 20, 30, 40, 50, or 60 minutes at an infrared wavelength. In some examples, the sample is illuminated multiple times, such as 10×1 minute (for a total of 10 minutes), 5×1 minute (for a total of 5 minutes), or 5×10 minutes (for a total of 50 minutes), and the multiple spectra generated are co-added.

After illuminating the seed(s), light emitted from the seed(s) is detected using a Raman spectrograph. For example, the generated spectra can be at a Raman shift of 10-4000 wavenumbers or 400 to 1800 wavenumbers. The spectrograph can output a spectra which is analyzed to determine the composition of the seed. In some examples the resulting spectra is averaged, corrected, or both for example to remove background, noise and aberrations. In some examples the method can include acquiring other images, for example to make corrections to the data, such as dark, white and neon frame images, that allow for correction and normalization of the resulting seed spectra. For example, the resulting spectra can be used to assign a particular value to a desired seed characteristic. In one example, spectra obtained from the light emitted from the seed is compared to a calibration curve or reference chart based on the chemistry of known samples (that is a curve or chart with known values for seed characteristics such as protein, amino acid, and oil content).

### EXAMPLE 1

### Instrumentation for Analyzing Single Seeds

This example describes Raman instrumentation that was developed to analyze soybean samples. One skilled in the art will appreciate that variations can be made to this particular setup, and that such instrumentation can be used to analyze other samples.

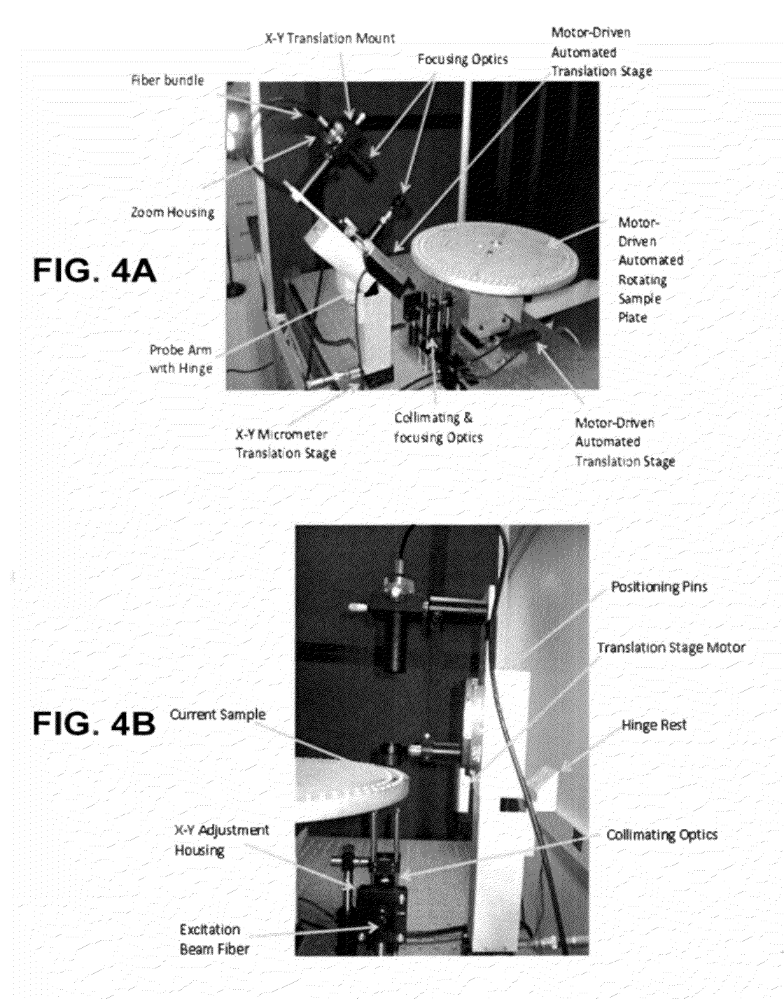

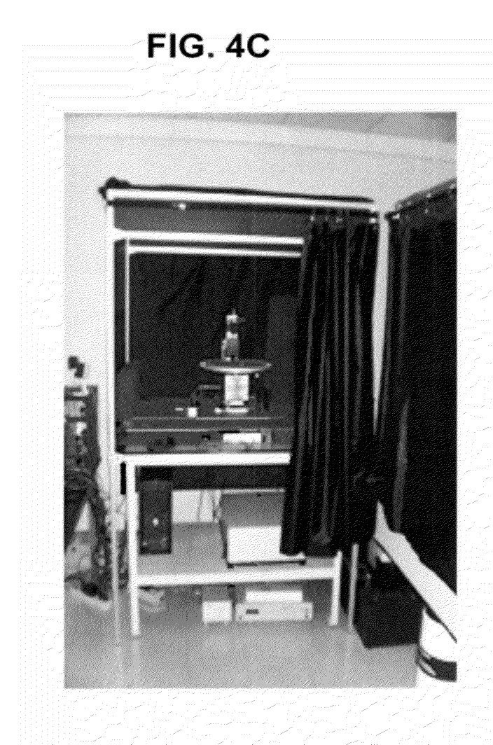

As shown in FIGS. 4A-4C, the instrument includes an illumination configuration in place below the sample stage. The illumination configuration is used to deliver near infrared light to the seed sample (located on the sample plate). The illumination configuration includes an excitation beam fiber (e.g., 785 nm NIR laser) and collimating and focusing optics below the sample plate. The NIR laser is focused from an optical fiber to a ˜2 mm spot size that is incident on the bottom side of the seed.

Light that is subsequently emitted from the seed sample is collected by a signal collection arm (which includes a fiber bundle and focusing optics) is positioned above the sample stage to collect the Raman signal that is transmitted through the seed. The fiber bundle transmits the collected light to the spectrograph (FIG. 4C, spectrograph located underneath the device).

The sample to be analyzed is located on the sample plate or stage, which is rotated by a motor. Four stage plates were machined to adjust the position of the soybean for size differences. This allows seed samples to be divided into quartiles based on each seed's major diameter. The stage connects to a stepper motor that rotates the seeds into position above the excitation laser and below the collection optics. Software was developed for instrument control, such that the rotation and data collection occur in concert.

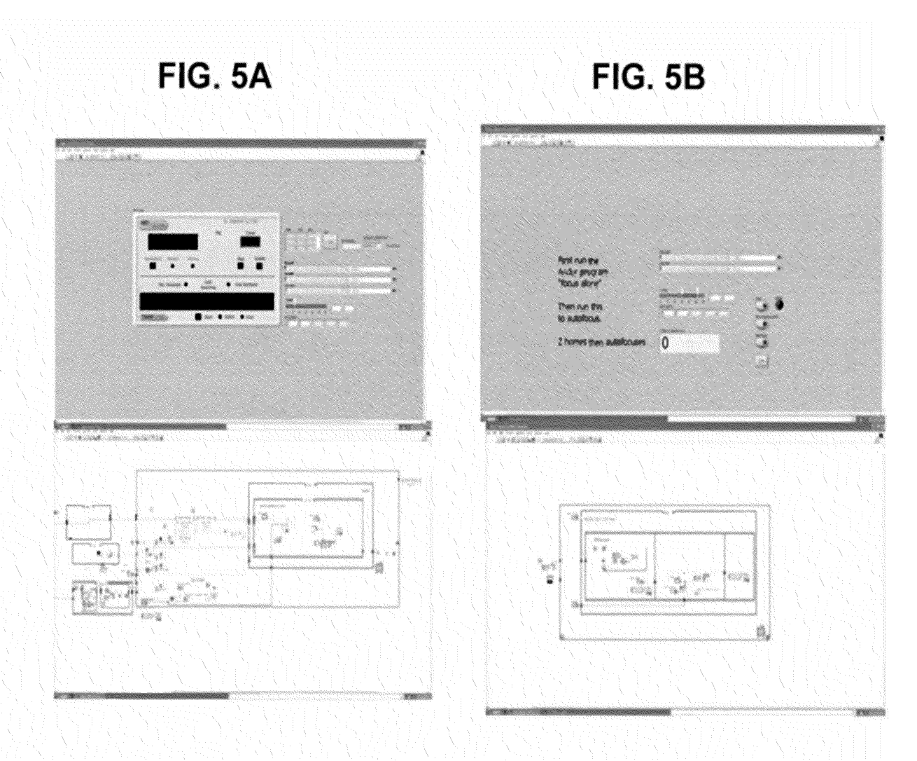

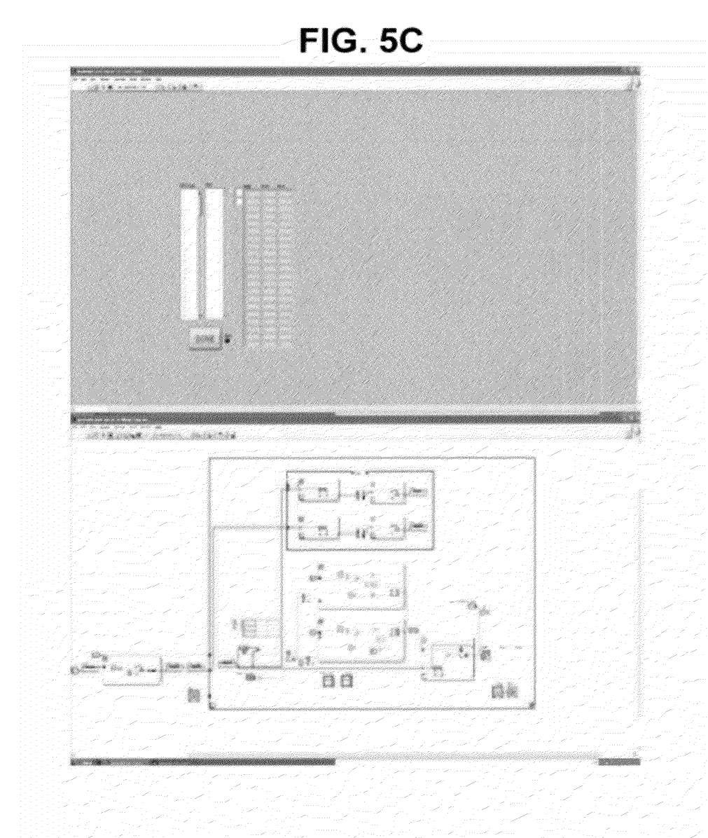

Software was developed that automated stage movement, automatically focus the collection arm onto the sample and then trigger the Raman spectrograph to collect several acquisitions. Exemplary screenshots shown in FIGS. 5A-5C show the Labview Front panel and block diagrams developed to control the above instrument (FIG. 5A, initial screen, FIG. 5B, auto focus, and FIG. 5C load soybean positions).

Raman measurements using this instrument have been completed on 120 soybeans and wet chemistry measurements completed to determine the oil (n=60) and protein (n=60) content on these soybeans, as described in Example 2.

### EXAMPLE 2

### Analysis of Soybeans Using Raman Spectroscopy

This example describes methods used to analyze soybeans using Raman spectroscopy. On skilled in the art will appreciate that similar methods can be used for other crop seeds, such as corn, rice and wheat.

To compare the protein and oil content calculating using Raman spectroscopy and wet chemistry, 20 different groups of soybeans with known and varied oil and protein content (from Illinois Crop Improvement Association) were analyzed. For a single Raman calibration set consisting of 20 protein points and 20 lipid points the following protocol was used. Gloves were worn while handling the soybeans. The instrument described in Example 1 was used.

The individual soybeans were weighed and then placed into individual wells/indentations on the sample stage. The stage was moved to the first soybean for sampling and the collection optics translated to optimize signal. Soybeans were illuminated at 785 nm for 1 minute and the resulting Raman spectra saved (ten one-minute acquisitions were acquired and saved for each soybean). The sample stage then moved to the next position and the process repeated for all soybeans.

After Raman spectra from the final soybean was acquired, a set of measurements under identical conditions are then acquired for a block of Teflon®, a piece of paper placed at the bottom of a sample well, and aluminum foil. The Teflon® was used as a Raman standard to calibrate laser power, instrument throughput, and pixel to wavelength conversion. The piece of paper was used to determine the position of the bottom of the well plate and can be used with the position of the focusing stage to determine the thickness of the soybean in each sample well. The aluminum foil was used to block the laser to allow for a set of acquisitions with no signal; this is used to correct for CCD dark current.

Measurements are then collected for white light and neon atomic emission generated using a NIST certified Raman calibration accessory (Kaiser Optical Systems, Inc.). These spectra were used to correct for instrument throughput and pixel to wavelength correction.

The Raman data were processed using matlab code as follows. The CCD frames containing the Raman data were converted to an .ascii format and imported into matlab.

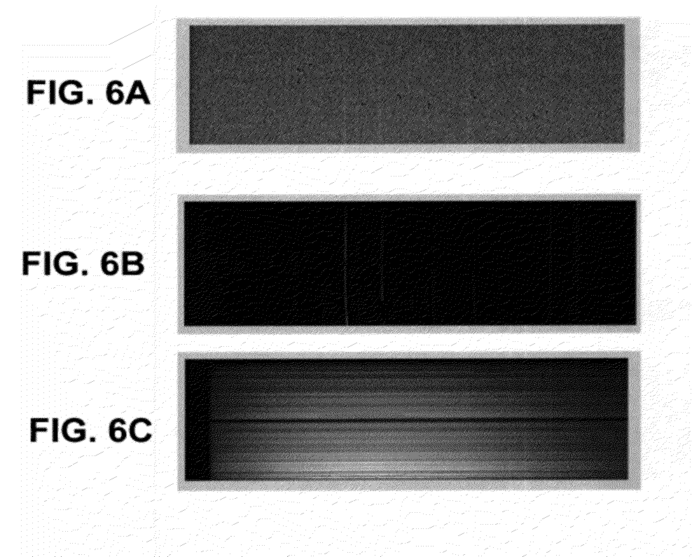

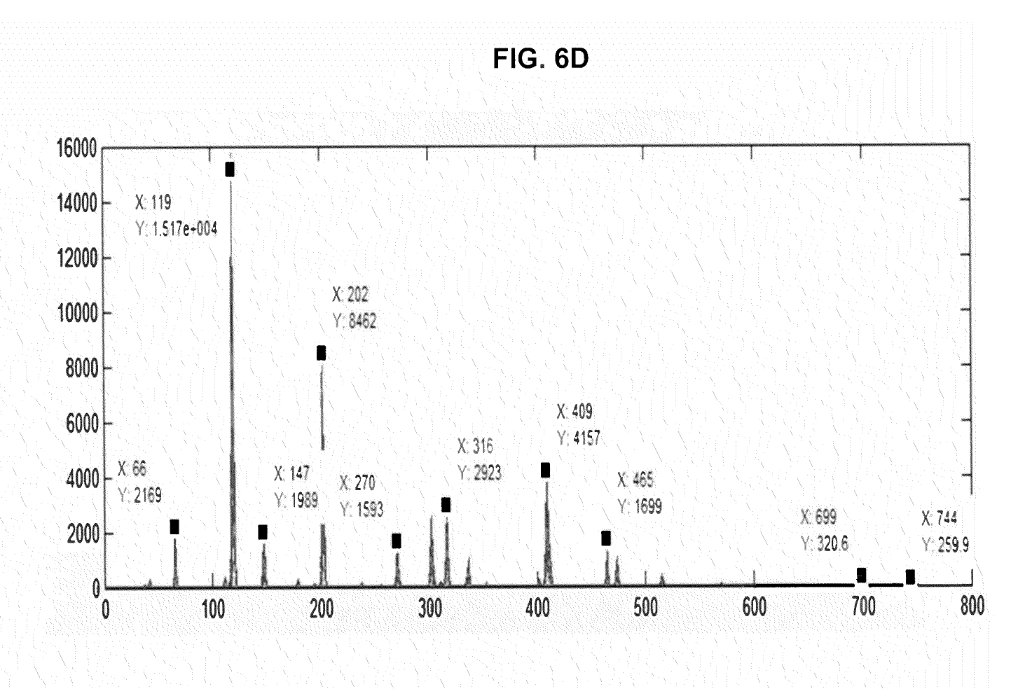

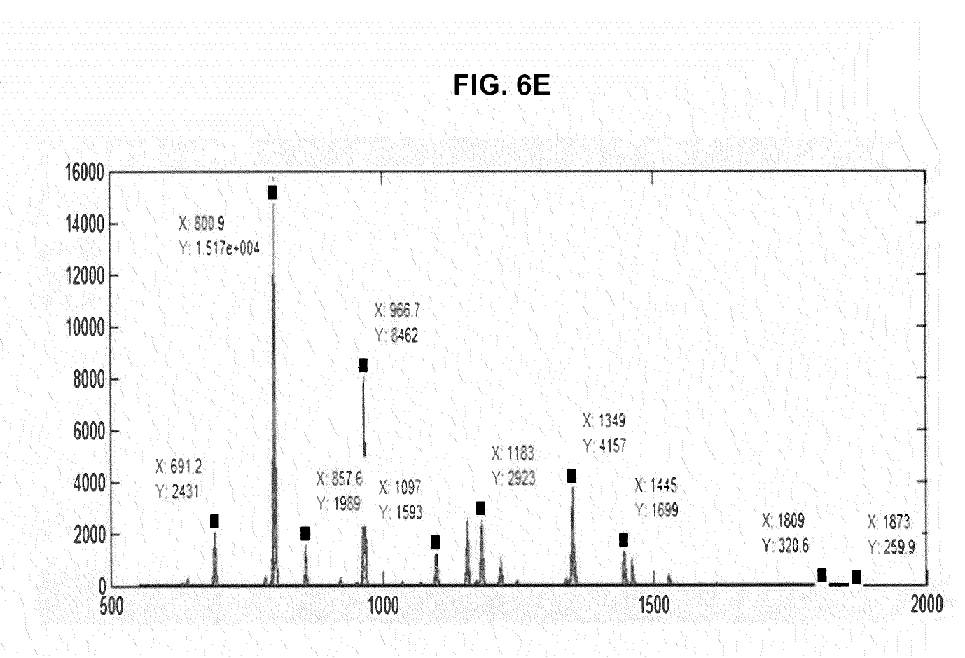

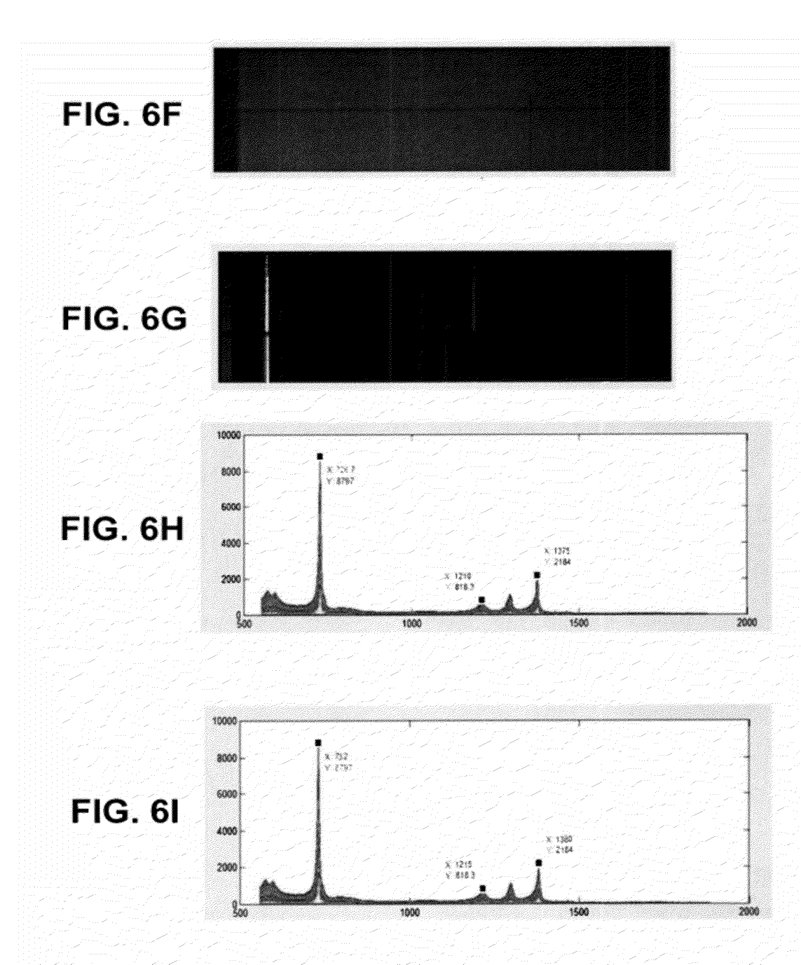

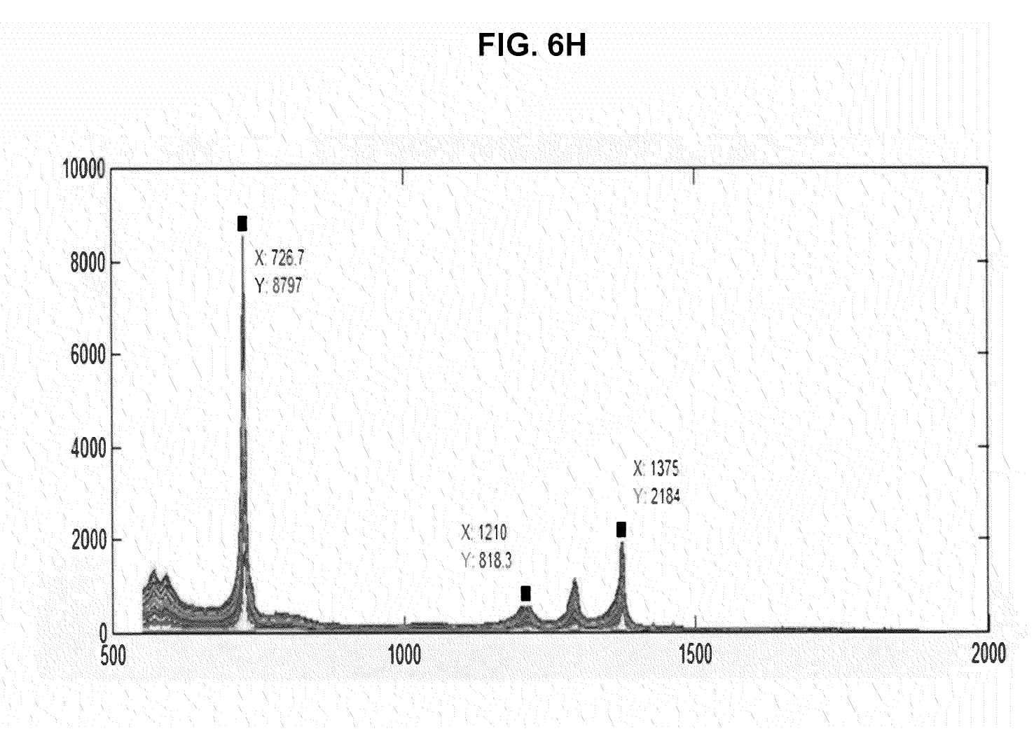

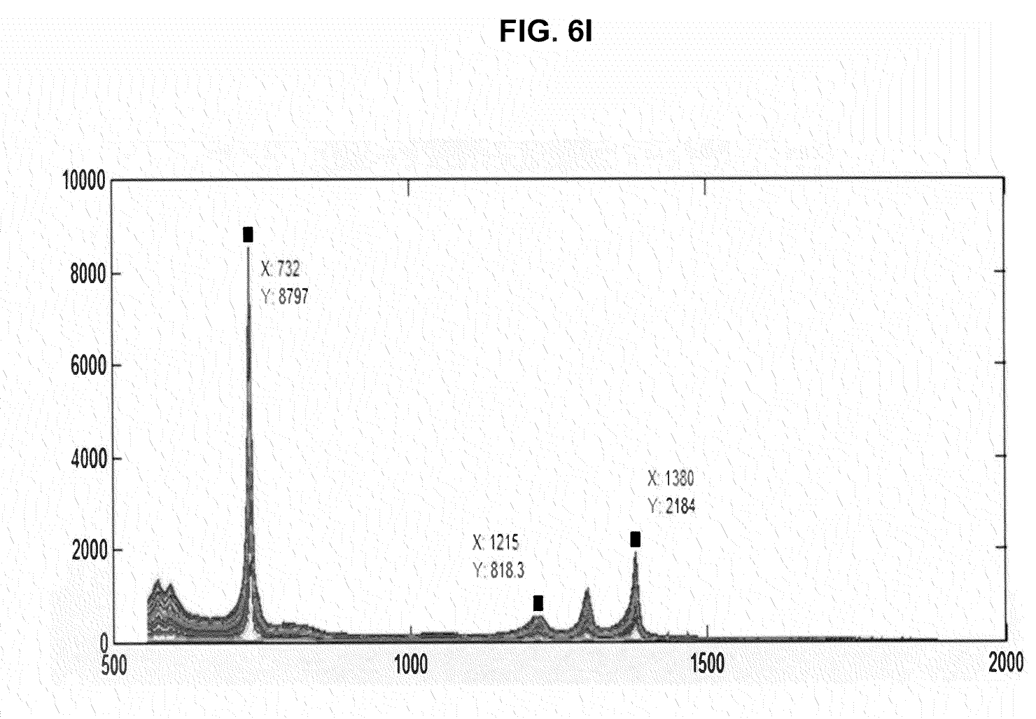

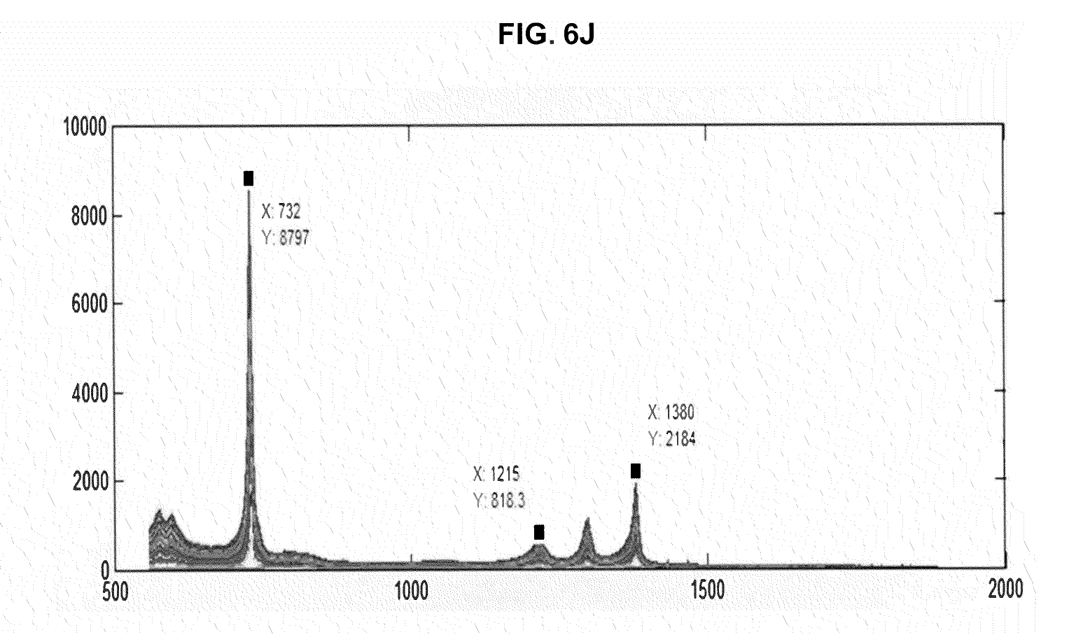

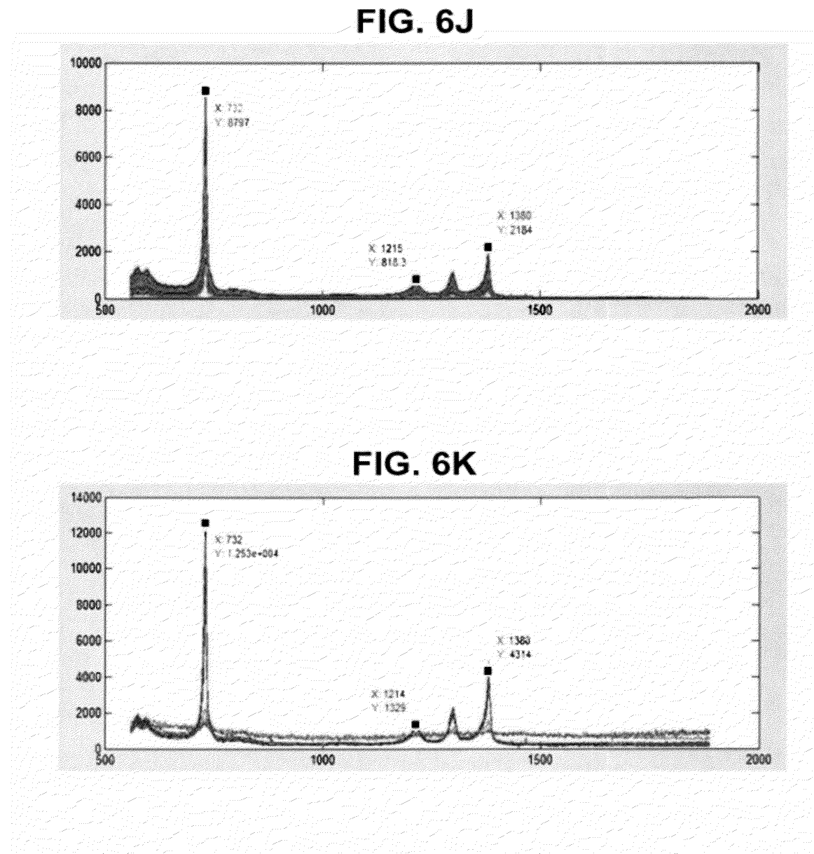

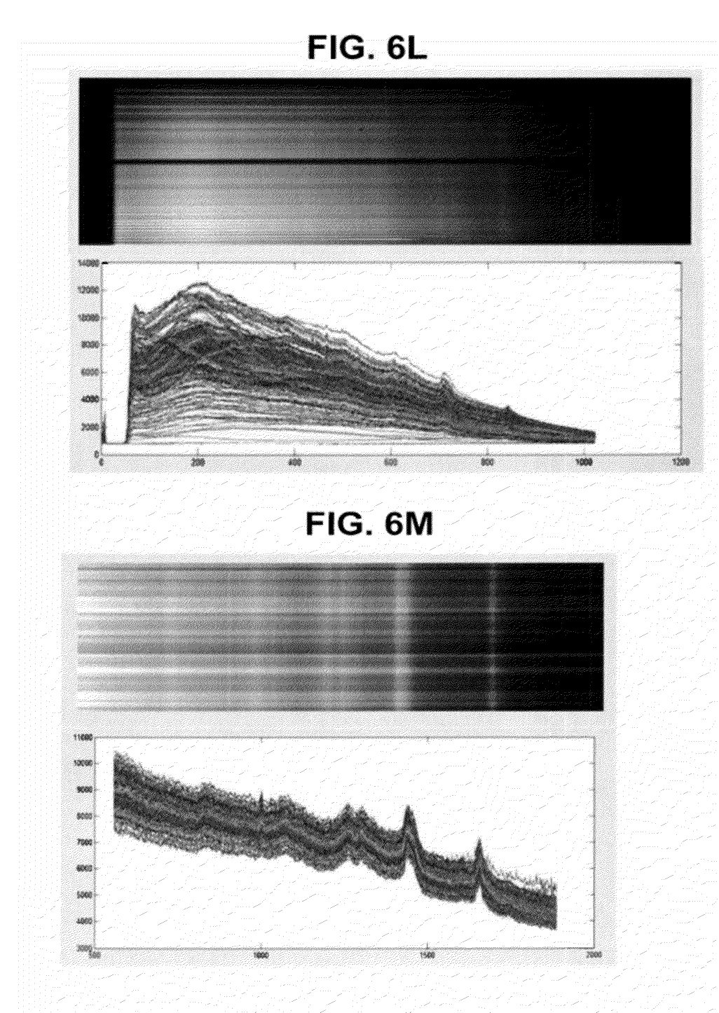

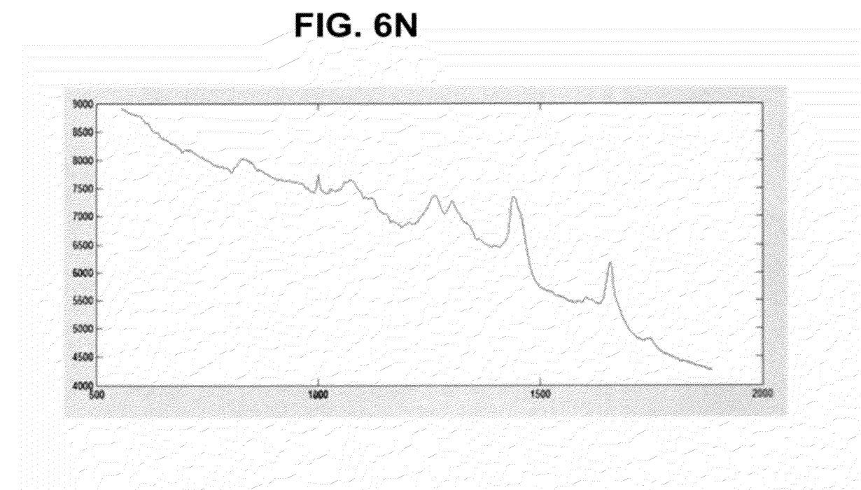

A dark current frame acquired at the same acquisition time as the white light and neon frame was unspiked by comparing two sequential frames and removing outlier pixels (FIG. 6A). The neon frame was then loaded, unspiked and the dark frame was subtracted (FIG. 6B). The white frame was then loaded, unspiked and the dark frame was subtracted (FIG. 6C). The white frame (FIG. 6C) and neon frame (FIG. 6B) were used generate a pincushion transform that corrects for CCD image curvature and CCD rotation. The resulting frame is then truncated to the useful region.

The x-axis was then converted from pixels (FIG. 6D) to Raman Shift in wavenumbers (FIG. 6E) using the neon frame (FIG. 6B) for calibration. A dark frame collected at the same acquisition time as the soybeans was then loaded and unspiked, resulting in FIG. 6F. The Teflon frame was then loaded, unspiked, and the sample time dark frame subtracted from the Teflon frame. The Teflon frame then underwent the same pincushion transform, resulting in FIG. 6G. This Teflon frame (FIG. 6G) was used to correct the wavelength axis for the laser band's spectral position (FIG. 6H, before, FIG. 6I after correction). The instrument/fiber through-put was found using the white light frame and used to normalize intensity. Before and after images are shown in FIGS. 6J and 6K, respectively.

Each soybean frame was loaded. For each frame, the frame was unspiked, the sample time dark frame subtracted, the pincushion transform implemented, and fiber to fiber intensity variations corrected for, and then the data is truncated. Before and after images are shown in FIGS. 6L and 6M, respectively. For each soybean the spectra (FIG. 6M) is averaged (FIG. 6N). At the end of this procedure a single representative spectrum for each soybean is obtained (e.g., FIG. 6N). Raman spectra were collected for 20 soybeans.

The spectra in FIG. 6N can be compared to a calibration curve and the concentration of various characteristics (such as protein and oil content) based on the spectral bands determined.

### EXAMPLE 3

### Soybean Composition Comparison Determined Using Raman Spectroscopy and Wet Chemistry

The Raman spectra collected for each of the 20 soybeans described in Example 2 was compared to the oil and protein content previously determined for the soybeans using wet chemistry analysis. This permitted comparison of the oil and protein content estimated by Raman spectroscopy as compared to wet chemistry analysis. The calibration model used is based on a PLS algorithm and leave-one-out analysis. however, one skilled in the art will appreciate that other algorithms can be used.

Inputs include the wet chemistry results for protein and oil and the Raman spectra for each of the soybeans. One of the soybeans was removed from the analysis, and the calibration model calculated using the ‘plsregress’ function in matlab. The model was evaluated by predicting the protein or oil concentration of the soybean that was left out from the Raman spectrum. This was accomplished using the ‘betaPLS’ variable that is generated from the ‘plsregress’ function. This was done for all 20 soybeans analyzed in Example 2, and the difference between the predicted and wet chemistry values analyzed.

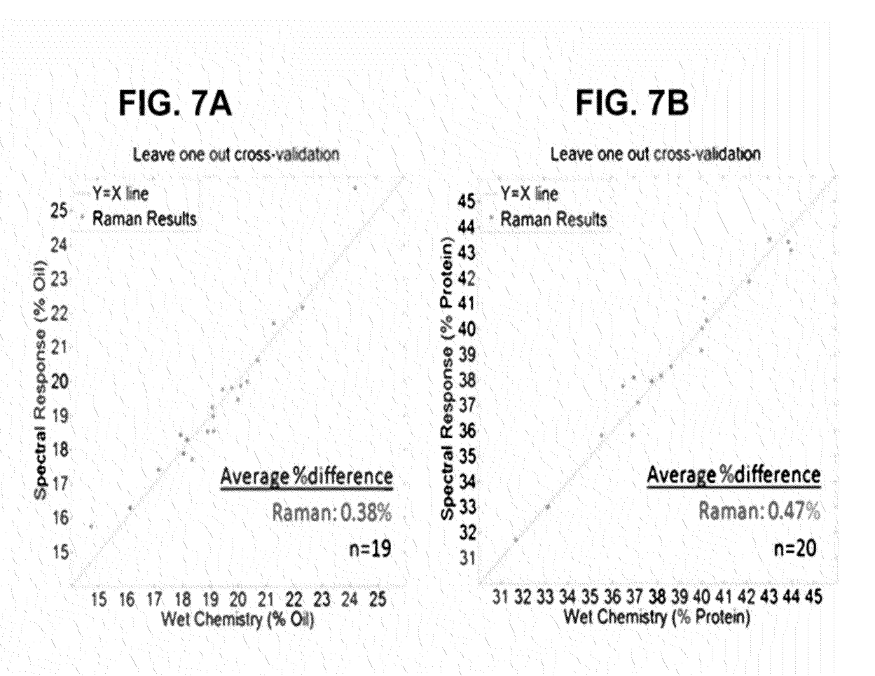

As shown in FIGS. 7A and B, the predicted oil (FIG. 7A) and protein (FIG. 7B) content using Raman spectroscopy (y-axis) and the known oil and protein contents determined using wet chemistry (x-axis) resulting in an average difference of only 0.38% for oil and 0.47% for protein. Thus, the results obtained for analyzing soybeans with Raman spectroscopy are very similar to those obtained using current methods of wet chemistry.

### EXAMPLE 4

### Instrumentation for Analyzing Seeds in Bulk

This example describes Raman instrumentation that was developed to analyze soybean samples in bulk (such as the analysis of a plurality of seeds). One skilled in the art will appreciate that variations can be made to this particular setup, and that such instrumentation can be used to analyze other samples.

As shown in FIGS. 8A-B, the instrument includes a funnel to hold the grain/seed, a turning screw mechanism to move the grain seed from the funnel into the sample chamber, a path adjustable sampling chamber, a trap-door to release the grain/seed from the sample chamber, permitting emptying of the sample chamber for additional runs. The process instrument can be automated and controlled by the program LabView. The optical path and associated optics for the instrument are shown in FIGS. 8A and 8C.

The illumination configuration is used to deliver near infrared light to the bulk seed sample (located in the sample chamber). The illumination configuration includes an excitation beam fiber (e.g., 785 nm NIR laser) and collimating and focusing optics on the opposite side of the sample chamber. For example, 785 nm light from a fiber optic is collimated to a 2 inch waste and directed through the sample chamber. After the light interacts with the sample it is collected with a spinning lens-let array (see FIG. 8C) which homogenizes the region collection providing both a high numerical aperture from a large field of view.

The sample to be analyzed is initially placed in the funnel. To introduce the seed into the seed chamber, the turning screw mechanism is adjusted to allow the seed/grain to move from the funnel into the sample chamber. The sample chamber can be configured so that it is adjustable to the size of the sampled to be analyzed. After analysis of that particular sample, the trap-door is adjusted to release the grain/seed from the sample chamber, permitting emptying of the sample chamber. The trap door is then closed, and the turn screw mechanism adjusted to allow another batch of seeds/grains to be introduced into the sample chamber for analysis. Software was developed for control of this process. The software controls the loading of the sample chamber. A sensor detects when the chamber is full and the filling is stopped. A signal is sent to the Raman spectrograph to acquire a measurement. When the measurement is complete a signal is sent to open the trap door under the sample chamber and the seeds/grains are emptied into a separate holding compartment. The door closes and then the process is repeated. The acquired data can be stored on a hard-drive for processing.

Raman measurements using this instrument have been completed on soybeans and wet chemistry measurements completed to determine the aspartic acid, lysine and sucrose content on these soybeans, as described in Example 5.

### EXAMPLE 5

### Analysis of Soybeans Using Raman Spectroscopy

This example describes methods used to analyze soybeans using Raman spectroscopy using the device described in Example 4. On skilled in the art will appreciate that similar methods can be used for other crop seeds, such as corn, rice and wheat.

To determine the aspartic acid, lysine and sucrose content using Raman spectroscopy, 26 different groups of soybeans with known and varied concentrations of amino acids, fatty acids and sugars (from Illinois Crop Improvement Association) were analyzed. For a single Raman calibration set consisting of 26 Raman spectra. Gloves were worn while handling the soybeans. The instrument described in Example 4 was used.

The soybeans were placed into the funnel. The screw was activated to allow about 90-100 soybeans to fill the sample chamber, while the trap door was closed. Soybeans were illuminated at 785 nm for 10 minutes and the resulting Raman spectra saved (one ten-minute acquisition was acquired and saved for each soybean population sampled). The trap door was then opened to allow the analyzed soybeans to be removed, then the trap door was closed, and the screw was adjusted to allow a new population of soybeans from the same variety (1 of the 26) to fill the sample chamber and an additional 10 minute measurement was acquired. This was repeated for a total of 5 samplings per variety totaling a 50 minute acquisition (one skilled in the art will appreciate that acquisition times can be decreased significantly with the addition of a better laser). This process repeated for the remaining 25 different batches of soybeans.

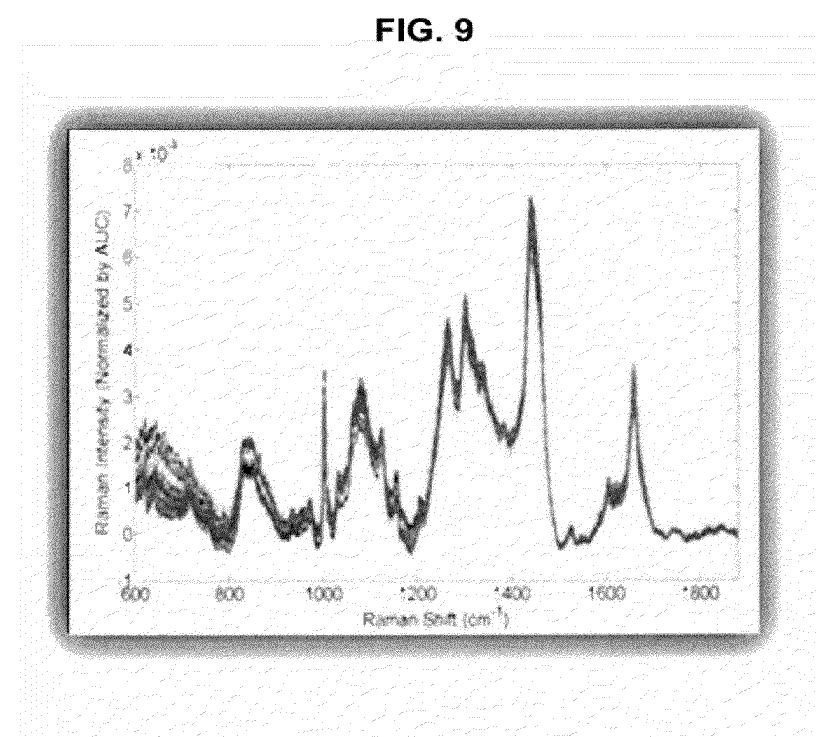

The path-length was 12.5 mm with a 2 inch diameter window giving a sampling volume of (3.14* 25.4̂2*12.5)=25322 mm̂3 assuming an average seed/grain is an 8 mm diameter sphere with a volume of ˜268 mm̂3 there were about 25322/268=94 seeds/grains/kernels per acquisition. For the initial analysis, the 5 runs performed were averaged, resulting in effectively sampling ˜500 seeds/grains/kernels. FIG. 8C shows the average TRS of five runs for one batch of soybeans and FIG. 9 shows the average TRS of five runs for 26 different batches of soybeans.

After Raman spectra from the final soybean population was acquired, a set of measurements under identical conditions are then acquired for a block of Teflon®, and without a light source to obtain the instruments dark response, as described in Example 2. Measurements were then collected for white light and neon atomic emission generated using a NIST certified Raman calibration accessory (Kaiser Optical Systems, Inc.). These spectra were used to correct for instrument throughput and pixel to wavelength correction as described in Example 2.

The Raman data were processed using matlab code as described in Example 2. For each soybean population, the spectra is averaged (FIG. 8C and 9). At the end of this procedure a single representative spectrum for each soybean is obtained (e.g., FIG. 8C). Raman spectra were collected for 26 soybean populations.

### EXAMPLE 6

### Generation of Calibration Models

This example describes methods used to generate calibration models for several seed components or attributes. Although specific teaching is provided for aspartic acid, lysine, and sucrose in soybeans, one skilled in the art will appreciate that similar methods can be used to generate calibration curves for any seed/grain and for any attribute of interest.

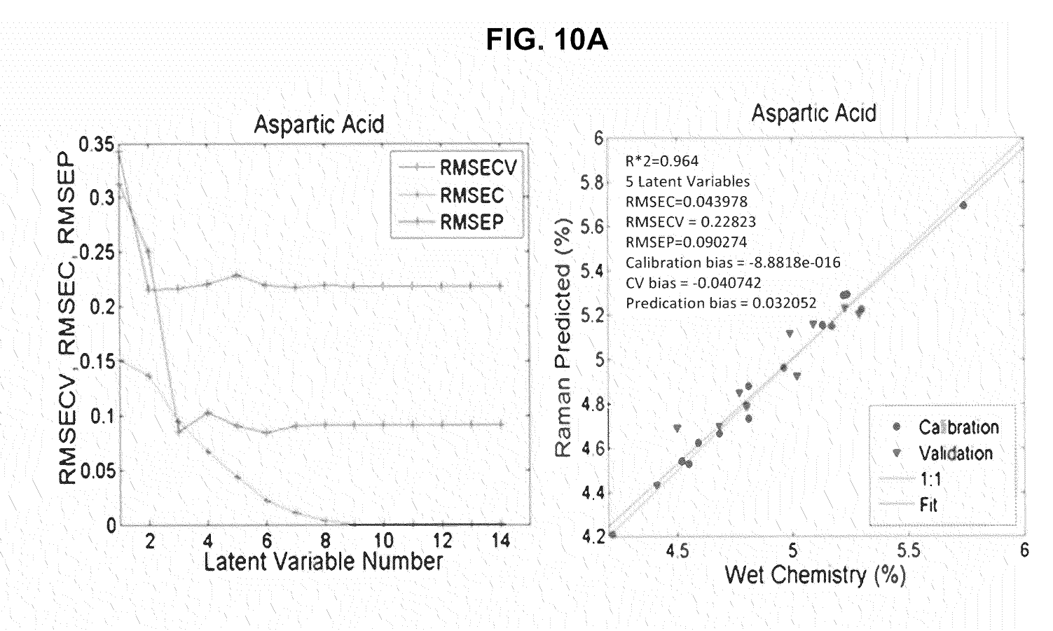

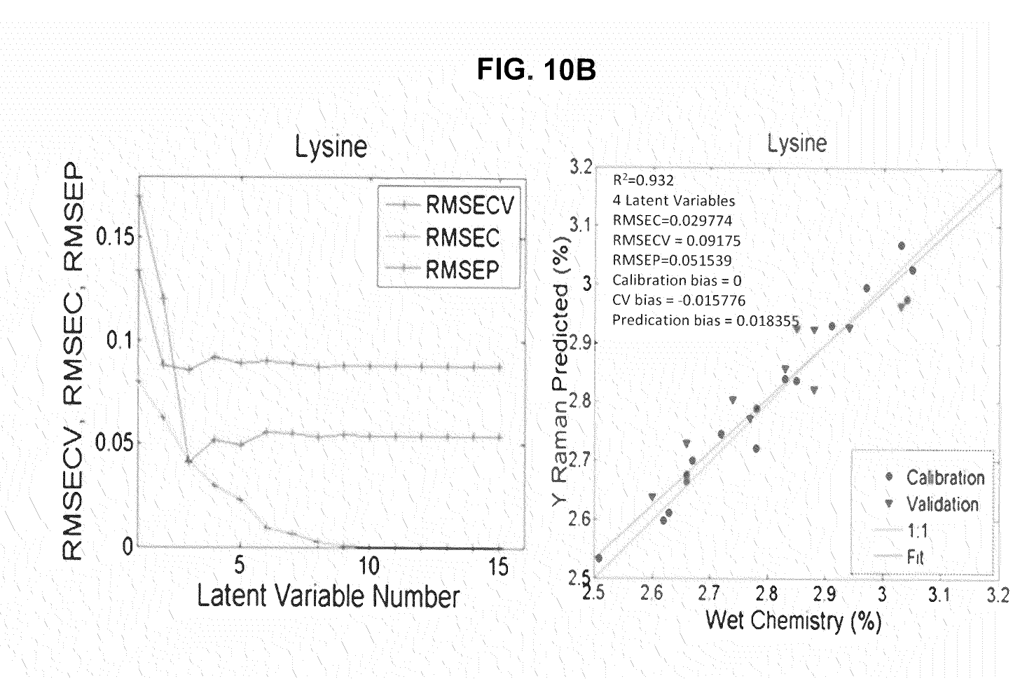

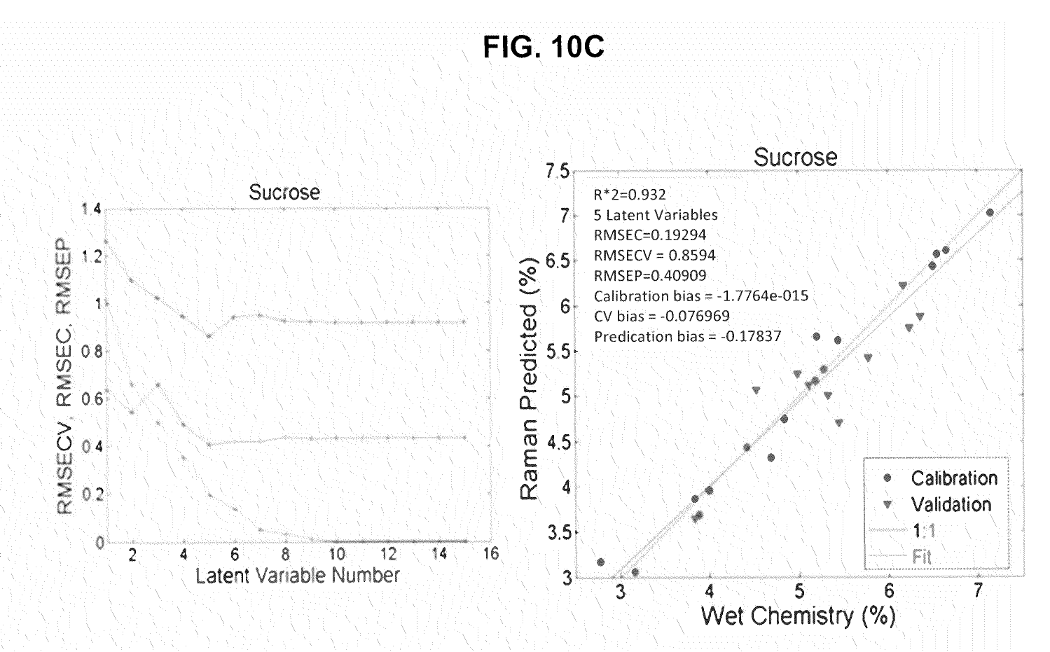

Calibration curves were generated for aspartic acid, lysine, and sucrose as follows. Sixteen of the twenty-six Raman spectrum were entered into a leave-one-out cross-validation partial least squares algorithm along with reference wet-chemistry values for aspartic acid, lysine, and sucrose to generate calibration model. The algorithm used for the preliminary data was from a matlab toolbox purchased from Eigenvector Research Inc. Preprocessing for all spectra included baselining and mean-centering the data. The calibration model generated was then used to predict the remaining 10 validation points. FIGS. 10A-C show the known reference values on the x-axis and the raman predicted values on the y-axis. Estimates in modeling error are illustrated in FIGS. 10A-C (graphs on the left) as the root mean standard error of prediction (RMSEP). FIGS. 10A-C (graphs on the right) show the merit for the calibration model.

FIGS. 10A-C demonstrate that values for aspartic acid, lysine, and sucrose can be determined using the disclosed methods and instrumentation. The graphs on the left hand side of FIGS. 10A-C show possible calibration model loadings (x-axis) and the route mean standard error of a calibration and prediction on the y-axis. This error is determined by examining the difference between the actual and predicted values and reporting the average differences under different model conditions. The graphs on the left hand side of FIGS. 10A-C illustrate that the models are not over-fit and have predictive capabilities. RMSE (route mean squared error) is a standard way of reporting a calibration models error. For example if the RMSE of a calibration model is 0.5%, this indicates that the value of the component can be predicted to a degree of certainty within 0.5% of the true value (e.g., +1-0.5%). RMSECV is another calibration validation approach used to generate a calibration model. This was done by using n number of points to generate a calibration model and then predicting an unused value using the developed model and looking at the difference between the actual and predicted values. This is a partial least square leave one out approach to generating a calibration model. RMSEC is the same as above only it only looks at the model without a leave one out validation. RMSEP uses an existing model to predict multiple points and is the best indicator of how well the calibration model performs as the model is unchanged between predictions. In general, for a good calibration model, the values of all three of these should be similar to each other with an r̂2 value that is 0.9 or higher.

The calibration curves shown on the right hand side of FIGS. 10A-C can be used to determine the aspartic acid, lysine, and sucrose amounts for a given soybean population, as described in Example 7.

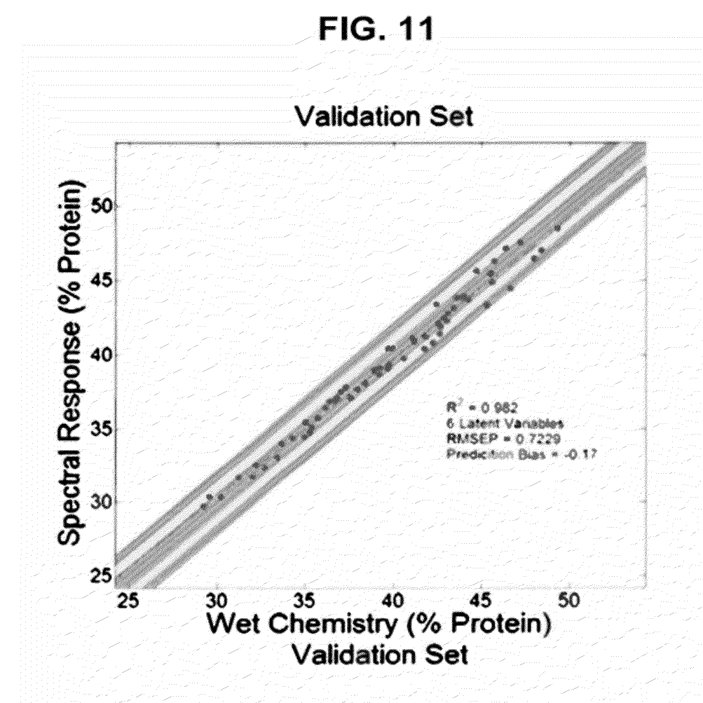

Another example of a calibration model is illustrated in FIG. 11, which shows a validation set of the predicted concentration for total protein in individual whole soybeans on the y-axis and the AOCS Ba 4e-93 combustion method for determining total protein content on the x-axis. This calibration model illustrates that Raman spectroscopy can be used in predicting total protein content in a soybean. A leave one out cross-validation model was generated to predict the percent protein and percent oil from a Raman spectrum using the wet chemistry results and the 40 spectra acquired from each of the soybean varieties. The model was built in Matlab2008b by using 39 of the 40 Raman spectra to generate a PLS regression model with the ‘plsregress’ function. The number of components used to generate the model for cross-validation was typically 5 components and was determined without user intervention by choosing the number of components that represented greater than 90% of the variation in the data set of 39 Raman spectra. The model was then used to predict the percent protein for the left-out soybean variety. This was repeated for each of the soybean varieties. The calibration model was evaluated by comparing the predicted protein concentrations to those determined by wet chemistry methods. This model, without further modification, was then applied to a separate set of 40 soybeans and predicted the protein values (y-axis). The figure compares the predicted values to the actual values obtained through wet chemistry procedures. The predicted values show very good agreement with the wet chemistry values thus validating the model.

As noted above, calibration models can be generated for other seeds/grains, as well as for other attributes. In one example, calibration models are generated for corn (Zea mays), wheat (Triticum aestivum), and rice (Oryza sativa) that reasonably span the range of constituent/attribute values typical for those grains. For example, for corn samples, calibration models for each of crude protein, crude oil, crude starch, primary amino acids, primary fatty acids, hardness/density, and mycotoxins can be generated as described above. For wheat, calibration models for each of crude protein, ash, hardness/density, falling number/a-amylase, gluten quality/quantity, and deoxynivalenol (DON) can be generated. For rice, calibration models for each of crude protein, amylose, lipids, chalkiness/hardness, and pasting viscosity can be generated.

The methods can performed on a set of 10-20 bulk sample characteristic/attribute values that span at least 80% of the typical range for a given characteristic/attribute. After the range of values is determined, the set will be randomized and Raman analysis will be conducted on the bulk samples. This approach can be used to develop leave-one-out cross-validation calibration models for each desired characteristic/attribute listed above. This can be followed-up by a calibration and validation set to evaluate the Raman method in a more rigorous manner. Additional samples and analyses can be added to the model set to increase the range, accuracy and/or precision of the model. The validation set will include secondary samples (a validation set) that demonstrate reasonable expectations for making successful predictions.

### EXAMPLE 7

### Determining Seed Characteristic from the TRS and Calibration Curves

The spectra shown in FIG. 9 were compared to the calibration curves shown in FIGS. 10A-C, and the concentration aspartic acid, lysine, and sucrose based on the spectral bands determined.

The calibration curves shown on the right hand side of FIGS. 10A-C were used to determine the aspartic acid, lysine, and sucrose amounts for each soybean population. The calibration model obtained using a leave one out cross-validation partial least squares regression approach is shown as circles (16 of the 26 data points) and the validation points (predicted values for concentrations) are shown as triangles. The predicted values were obtained by applying the calibration model to Raman spectra for (remaining 10 of the 26 data points) while the calibration model remained unchanged for these predictions. The predicted values are in good agreement with the reference (wet chemistry values) thus validating the calibration model and illustrating the predictive power of the Raman approach.

In summary, the disclosed instrumentation and devices can be used to determine the composition of seeds, for example by determining one or more of their components. It is shown herein that by using a calibration model, the components can be determined or predicted (for example determining a qualitative or quantitative value for a particular characteristic).

In view of the many possible embodiments to which the principles of the disclosure may be applied, it should be recognized that the illustrated embodiments are only examples of the disclosure and should not be taken as limiting the scope of the invention. Rather, the scope of the disclosure is defined by the following claims. We therefore claim as our invention all that comes within the scope and spirit of these claims.

We claim:

1. A method of determining the composition of a seed, comprising:
analyzing the seed using transmission Raman spectroscopy, thereby determining the composition of the seed.

2. The method of claim 1, wherein analyzing the seed using transmission Raman spectroscopy comprises:
illuminating the seed with a wavelength of near infrared light; and
detecting light emitted from the seed using a Raman spectrograph, thereby generating a spectra.

3. The method of claim 2, wherein detecting the light emitted from the seed further comprises assigning the spectra to a particular seed characteristic or component.

4. The method of claim 2, further comprising comparing the light emitted from the seed to a calibration curve based on reference chemistry of known samples and sample component values.

5. The method of claim 2, wherein the infrared light is 700 nm to 900 nm.

6. The method of claim 2, wherein the wavelength of light is 785±5 nm.

7. The method of claim 1, wherein the seed is illuminated for 5 minutes.

8. The method of claim 2, wherein the spectra are at a Raman shift of 1 to 4000 wavenumbers or 400 to 1800 wavenumbers.

9. The method of claim 1, wherein the seed comprises soybean, corn, wheat, or rice.

10. The method of any of claim 1, wherein the composition of the seed comprises one or more of protein content, oil content, amino acid content, fatty acid content, or sugar content.

11. An instrument, comprising:
an illumination device;
a sample holder capable of holding one or more seeds, wherein the illumination device is positioned on one side of the sample holder; and
a collection device, wherein the collection device is positioned on another side of the sample holder.

12. The instrument of claim 11, wherein the sample holder comprises a sample stage or sample chamber.

13. The instrument of claim 11, wherein the illumination device comprises a laser capable of emitting light in the near infrared range.

14. The instrument of claim 11, wherein the illumination device further comprises a fiber optic bundle, collimating optics, and focusing optics, wherein the fiber optic bundle transmits light to collimating and focusing optics.

15. The instrument of claim 12, wherein the sample stage comprises a plurality of concentric indentations.

16. The instrument of claim 11, wherein the collection device comprises a spectrograph with a low frequency Raman shift 400-1800 cm⁻¹.

17. The instrument of claim 16, wherein the collection device further comprises a fiber optic bundle connected to the spectrograph, such that light from the fiber optic bundle can be transmitted to the spectrograph.

18. The instrument of claim 11, wherein the collection device further comprises a focusing optics.

19. The instrument of claims 11, wherein the collection optics comprise a cylinder lens, Powel lens, or a lenslet array.

20. A method of determining the composition of a seed, comprising:
analyzing the seed using the instrument of claim 11, thereby determining the composition of the seed.
